(19) United States
(12) Patent Application Publication
(10) Pub. No.: US 2026/0140289 A1
(43) Pub. Date: May 21, 2026

(54) IMAGING LENS ASSEMBLY AND ELECTRONIC DEVICE

(71) Applicant: LARGAN PRECISION CO., LTD., Taichung City (TW)

(72) Inventors: Chen-Wei FAN, Taichung City (TW); Yo Him CHEN, Taichung City (TW); Jyun-Jia CHENG, Taichung City (TW)

(21) Appl. No.: 19/389,134

(22) Filed: Nov. 14, 2025

Related U.S. Application Data
(60) Provisional application No. 63/721,653, filed on Nov. 18, 2024.

(51) Int. Cl. G02B 5/04; G02B 1/04

(52) U.S. Cl. CPC G02B 5/04; G02B 1/041

(57) ABSTRACT

An imaging lens assembly includes a plastic optical element. The plastic optical element includes an incident surface, a reflection surface, an exit surface and a connection surface. An imaging light enters the plastic optical element through the incident surface, changes a traveling direction through the reflection surface and exits the plastic optical element through the exit surface. The connection surface is used to connect the incident surface, the reflection surface and the exit surface, and includes a gate vestige, a divergent nozzle surface and a cut vestige. The gate vestige is disposed on the connection surface, and is elevated relative to an adjacent portion. The divergent nozzle surface is connected to the gate vestige and the adjacent portion, and diverges and extends from the gate vestige toward the adjacent portion. The cut vestige is disposed on a surface of the gate vestige.

### RELATED APPLICATIONS

This application claims priority to U.S. Provisional Application Ser. No. 63/721,653, filed Nov. 18, 2024, which is herein incorporated by reference.

### BACKGROUND

### Technical Field

The present disclosure relates to an imaging lens assembly. More particularly, the present disclosure relates to an imaging lens assembly which is applicable to portable electronic device.

### Description of Related Art

In recent years, portable electronic devices have developed rapidly. For example, intelligent electronic devices and tablets have been filled in the lives of modern people, and imaging lens assemblies mounted on portable electronic devices have also prospered. However, as the technology advances, the quality requirements of imaging lens assembly are becoming higher and higher. Therefore, developing an imaging lens assembly that is favorable for the subsequent light blocking process to reduce the stray light generated around the gate vestige has become an important and urgent problem in the industry.

### SUMMARY

According to one aspect of the present disclosure, an imaging lens assembly includes a plastic optical element. The plastic optical element includes an incident surface, a reflection surface, an exit surface and at least one connection surface. An imaging light enters the plastic optical element through the incident surface, changes a traveling direction through the reflection surface and exits the plastic optical element through the exit surface. The connection surface is used to connect the incident surface, the reflection surface and the exit surface, wherein the connection surface includes a gate vestige, a divergent nozzle surface and a cut vestige. The gate vestige is disposed on the connection surface, and the gate vestige is elevated relative to an adjacent portion of the connection surface. The divergent nozzle surface is connected to the gate vestige and the adjacent portion, and the divergent nozzle surface diverges and extends from the gate vestige toward a direction of the adjacent portion. The cut vestige is disposed on a surface of the gate vestige, wherein an outline of the cut vestige is linear, and the cut vestige extends across the surface of the gate vestige. When a projection along a direction in a front view of the adjacent portion of the connection surface, a projection area of the divergent nozzle surface is As, a projection area of the gate vestige is Ag, the following condition is satisfied: 0.08≤As/Ag≤0.68.

According to another aspect of the present disclosure, an imaging lens assembly defines an optical axis and includes a plastic optical element. The plastic optical element includes an incident surface, a reflection surface, an exit surface and at least one connection surface. An imaging light enters the plastic optical element through the incident surface, changes a traveling direction through the reflection surface and exits the plastic optical element through the exit surface. The connection surface is used to connect the incident surface, the reflection surface and the exit surface, wherein the connection surface includes a gate vestige, a divergent nozzle surface and a cut vestige. The gate vestige is disposed on the connection surface, and the gate vestige is elevated relative to an adjacent portion of the connection surface. The divergent nozzle surface is connected to the gate vestige and the adjacent portion, and the divergent nozzle surface diverges and extends from the gate vestige toward a direction of the adjacent portion. The cut vestige is disposed on a surface of the gate vestige, wherein an outline of the cut vestige is linear, and the cut vestige extends across the surface of the gate vestige. When an elevation height of the gate vestige relative to the adjacent portion is Hs, a perpendicular distance between the surface of the gate vestige and the optical axis is Dg, the following condition is satisfied: 0.02≤Hs/Dg≤0.12.

According to further another aspect of the present disclosure, an imaging lens assembly includes a plastic optical element. The plastic optical element includes an incident surface, an exit surface and at least one connection surface. An imaging light enters the plastic optical element through the incident surface and exits the plastic optical element through the exit surface. The connection surface is used to connect the incident surface and the exit surface, wherein the connection surface includes a gate vestige, a divergent nozzle surface and a cut vestige. The gate vestige is disposed on the connection surface, and the gate vestige is elevated relative to an adjacent portion of the connection surface. The divergent nozzle surface is connected to the gate vestige and the adjacent portion, and the divergent nozzle surface diverges and extends from the gate vestige toward a direction of the adjacent portion. The cut vestige is disposed on a surface of the gate vestige, wherein an outline of the cut vestige is linear, and the cut vestige extends across the surface of the gate vestige. When a projection along a direction in a front view of the adjacent portion of the connection surface, a projection area of the divergent nozzle surface is As, a projection area of the gate vestige is Ag, the following condition is satisfied: 0.08≤As/Ag≤0.68.

According to still another aspect of the present disclosure, an imaging lens assembly defines an optical axis and includes a plastic optical element. The plastic optical element includes an incident surface, an exit surface and at least one connection surface. An imaging light enters the plastic optical element through the incident surface and exits the plastic optical element through the exit surface. The connection surface is used to connect the incident surface and the exit surface, wherein the connection surface includes a gate vestige, a divergent nozzle surface and a cut vestige. The gate vestige is disposed on the connection surface, and the gate vestige is elevated relative to an adjacent portion of the connection surface. The divergent nozzle surface is connected to the gate vestige and the adjacent portion, and the divergent nozzle surface diverges and extends from the gate vestige toward a direction of the adjacent portion. The cut vestige is disposed on a surface of the gate vestige, wherein an outline of the cut vestige is linear, and the cut vestige extends across the surface of the gate vestige. When an elevation height of the gate vestige relative to the adjacent portion is Hs, a perpendicular distance between the surface of the gate vestige and the optical axis is Dg, the following condition is satisfied: 0.02≤Hs/Dg≤0.12.

+

According to yet another aspect of the present disclosure, an electronic device includes the imaging lens assembly of any one of the aforementioned aspects.

### BRIEF DESCRIPTION OF THE DRAWINGS

The present disclosure can be more fully understood by reading the following detailed description of the embodiment, with reference made to the accompanying drawings as follows:

FIG. 1A is a schematic view of an imaging lens assembly according to the 1st Embodiment of the present disclosure.

FIG. 1B is a three-dimensional schematic view of the plastic optical element according to the 1st Embodiment in FIG. 1A.

FIG. 1C is a side view of the plastic optical element according to the 1st Embodiment in FIG. 1B.

FIG. 1D is a partial enlarged view of a cross-section of the plastic optical element along line 1D-1D according to the 1st Embodiment in FIG. 1C.

FIG. 1E is a schematic view of the connection surface of the plastic optical element according to the 1st Embodiment in FIG. 1B.

FIG. 1F is a schematic view of the connection surface of the plastic optical element of the 1st Example according to the 1st Embodiment in FIG. 1B.

FIG. 1G is a schematic view of the connection surface of the plastic optical element of the 2nd Example according to the 1st Embodiment in FIG. 1B.

FIG. 1H is a partial enlarged view of a cross-section of the plastic optical element of the 3rd Example according to the 1st Embodiment in FIG. 1B.

FIG. 11 is a partial enlarged view of a cross-section of the plastic optical element of the 4th Example according to the 1st Embodiment in FIG. 1B.

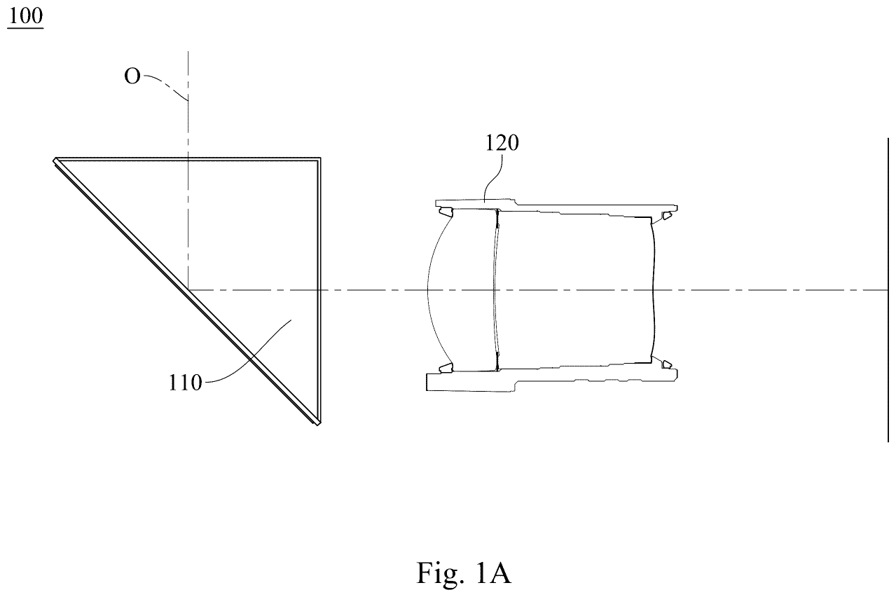

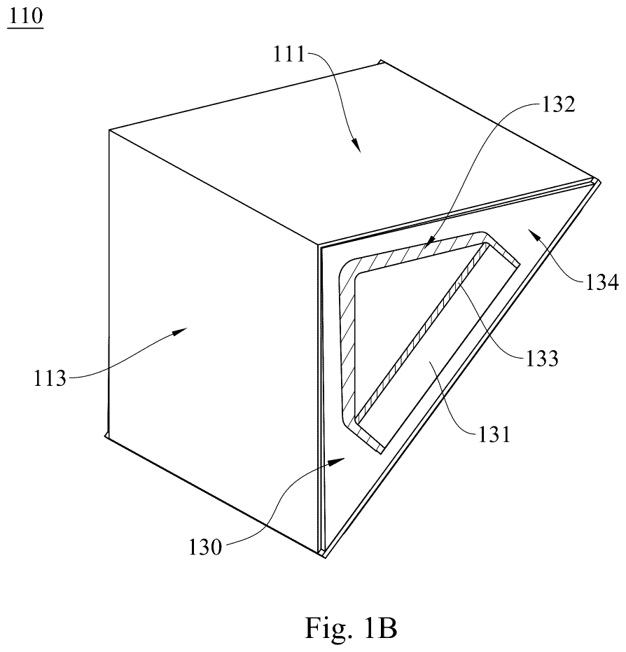

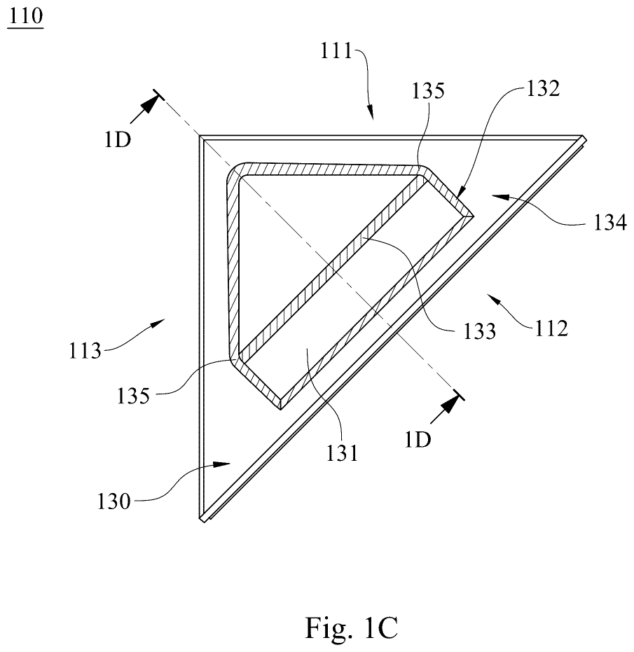

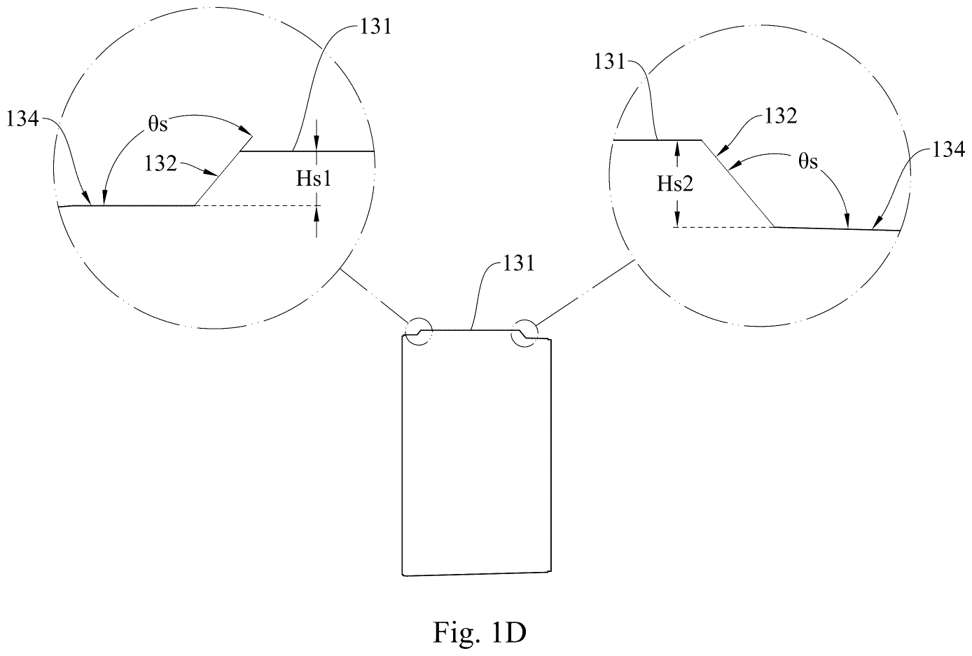

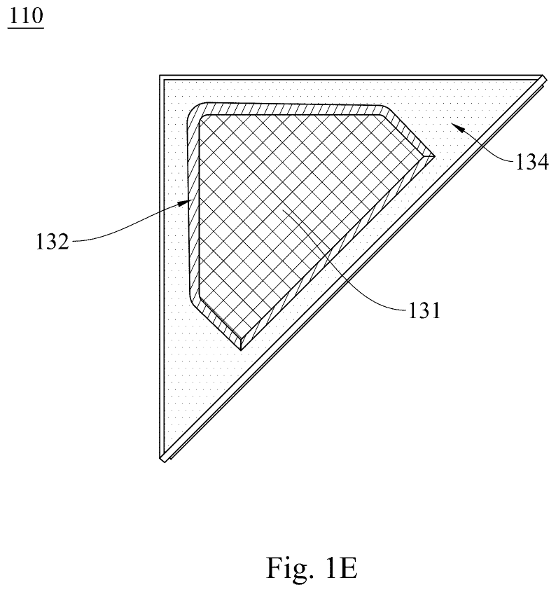

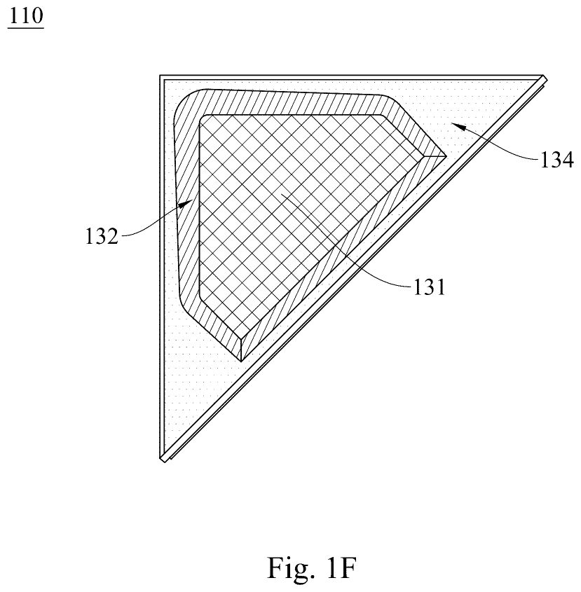

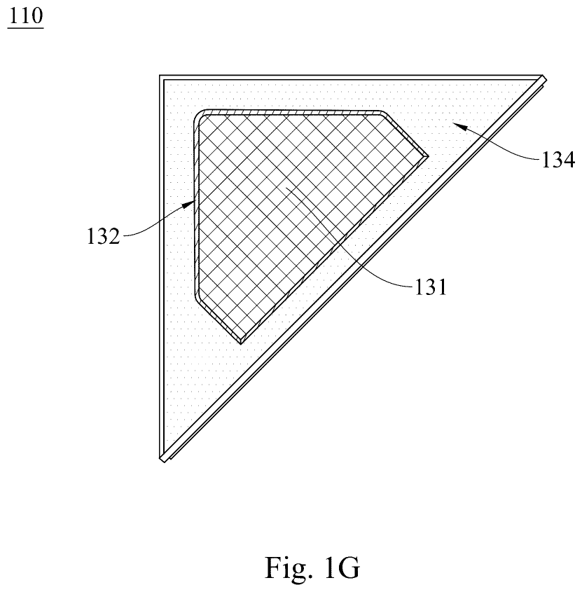

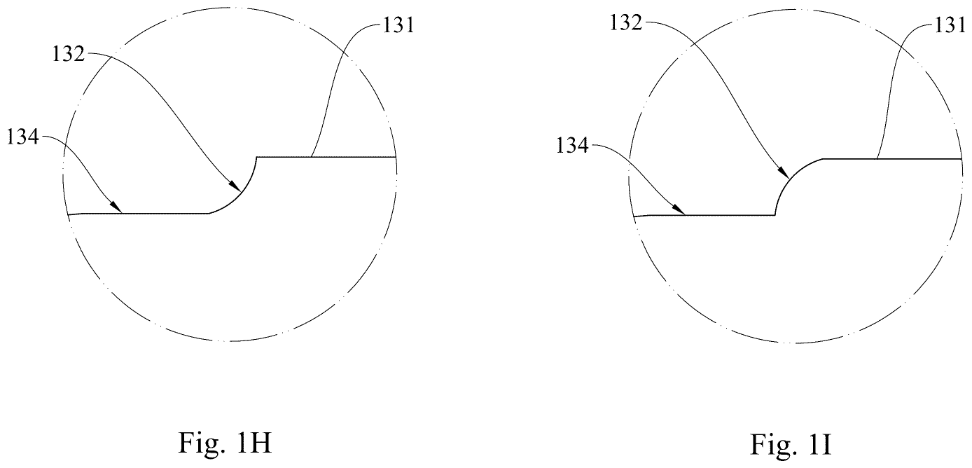

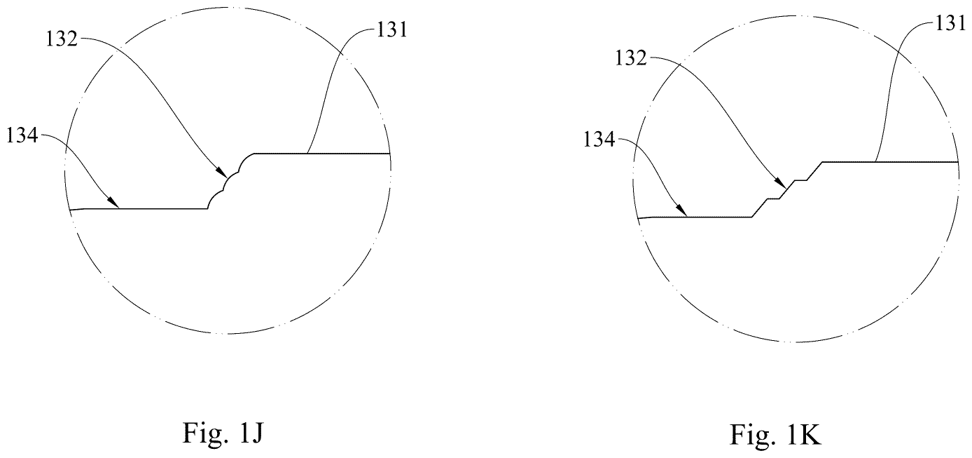

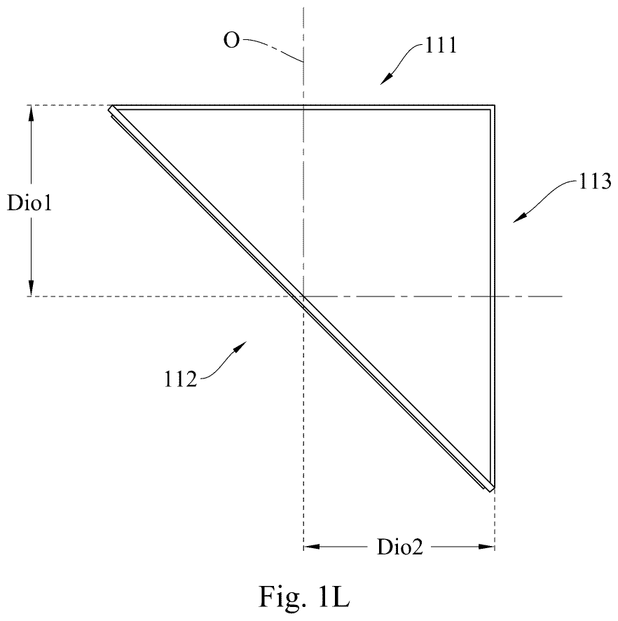

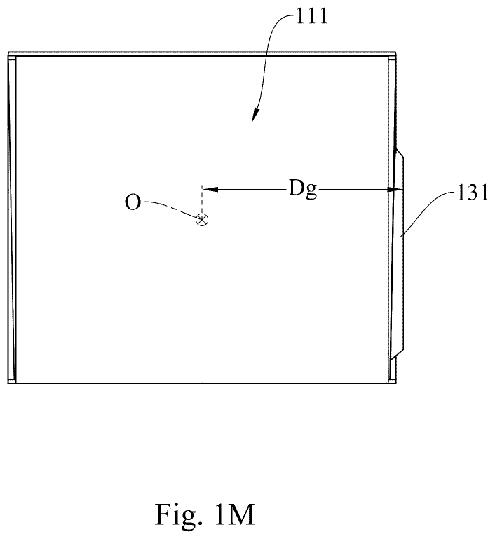

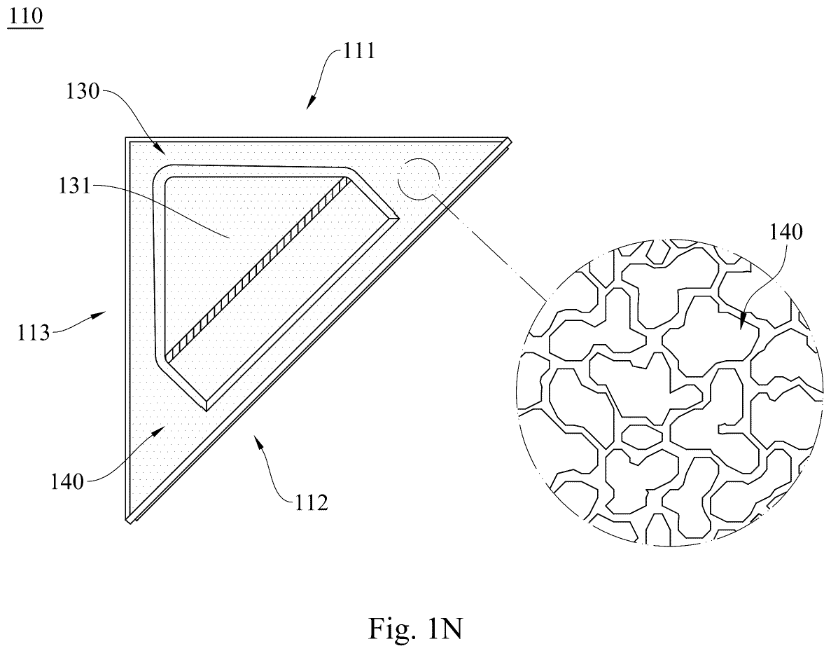

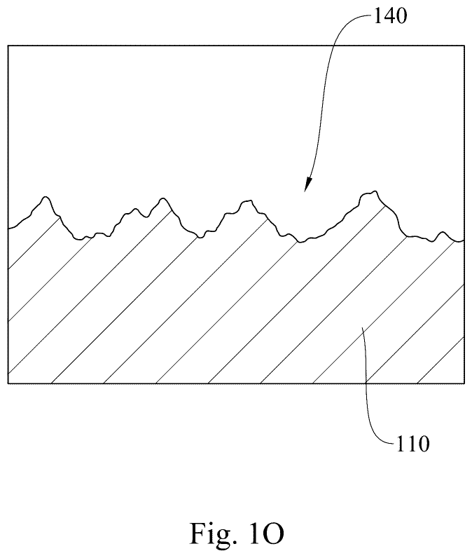

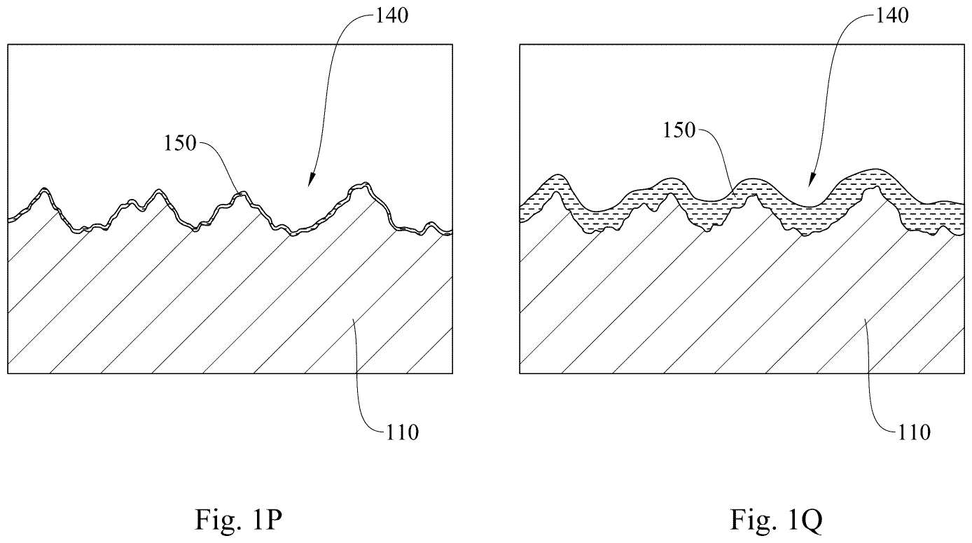

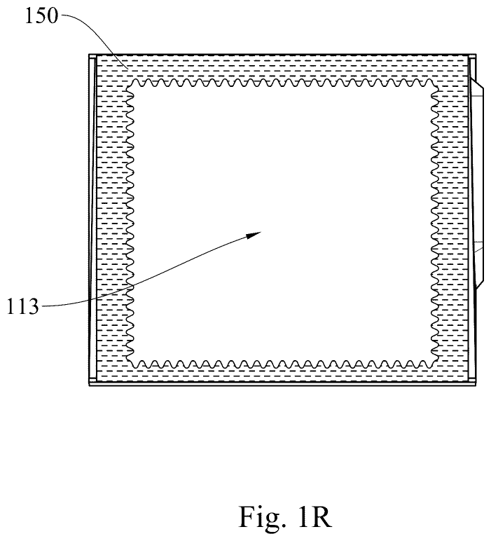

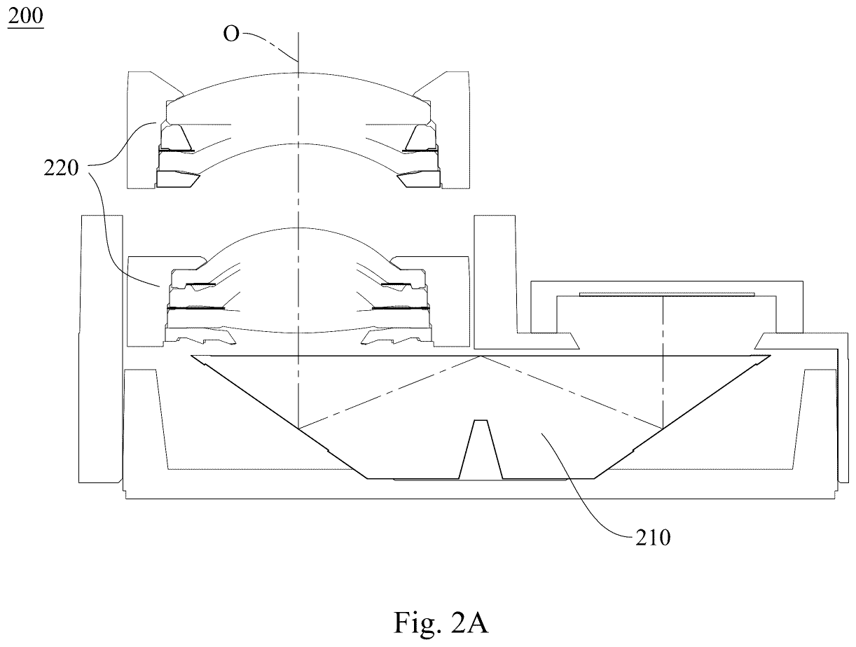

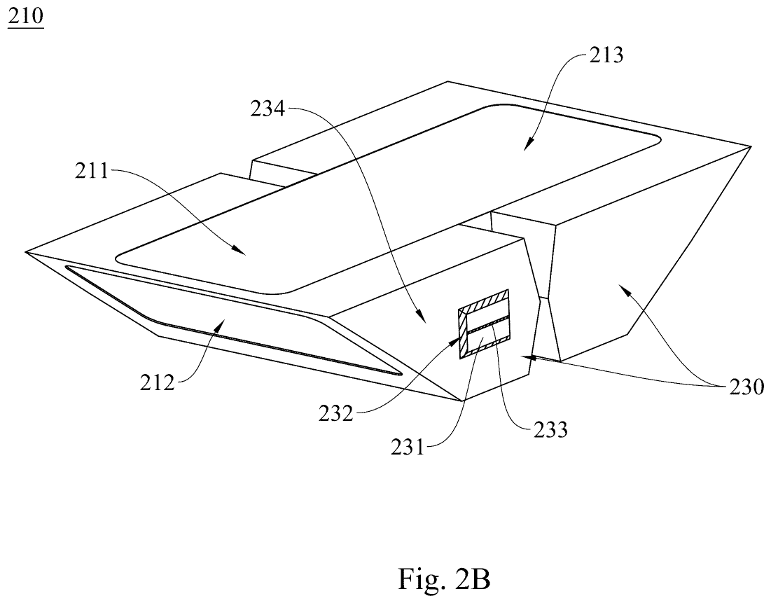

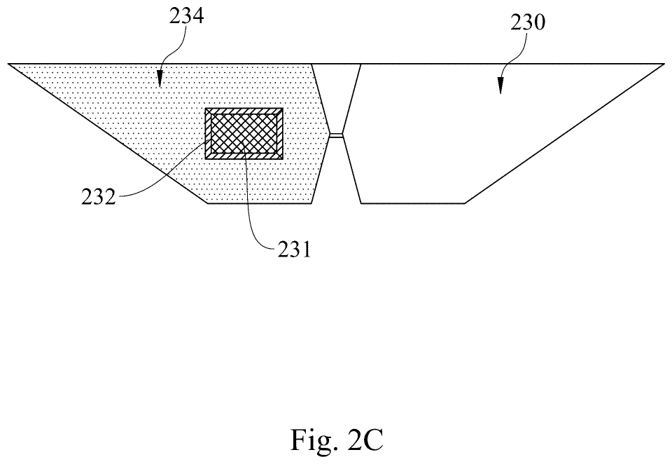

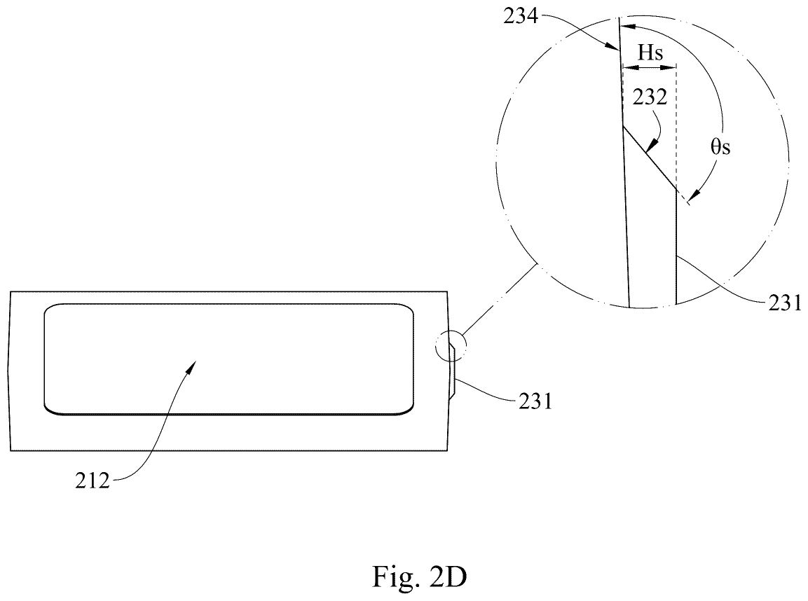

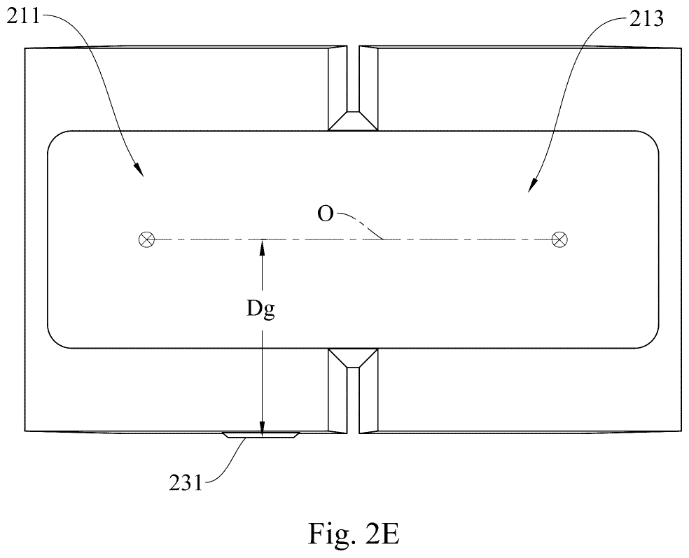

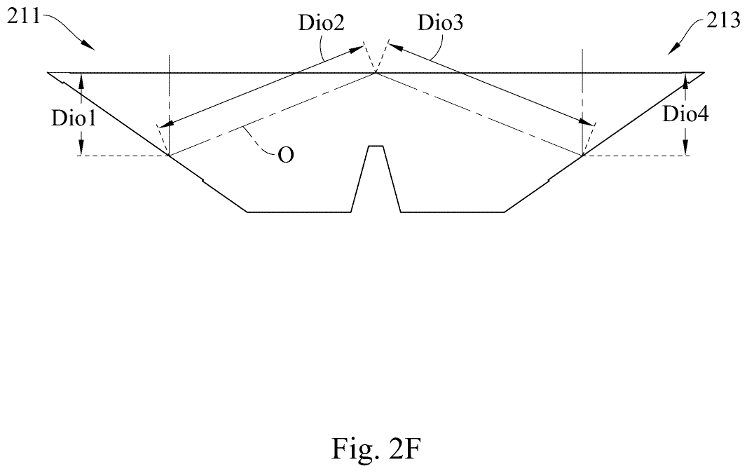

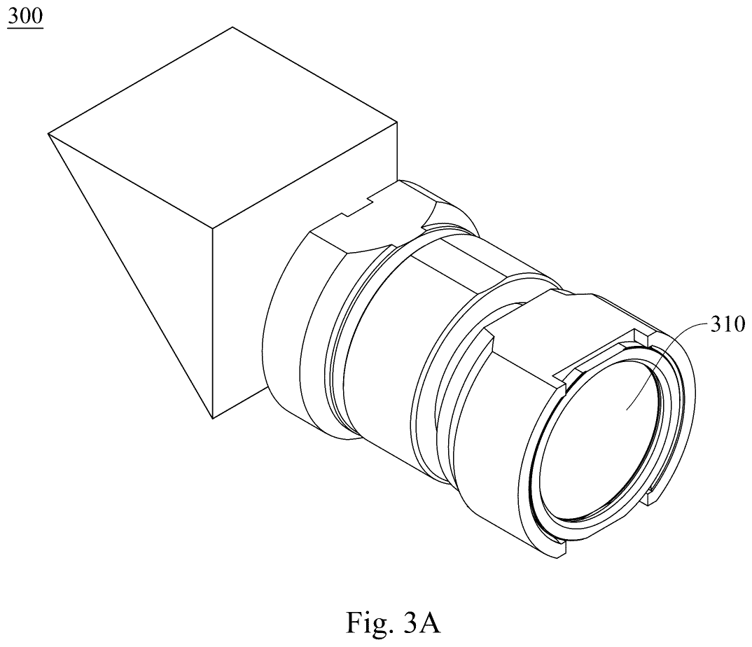

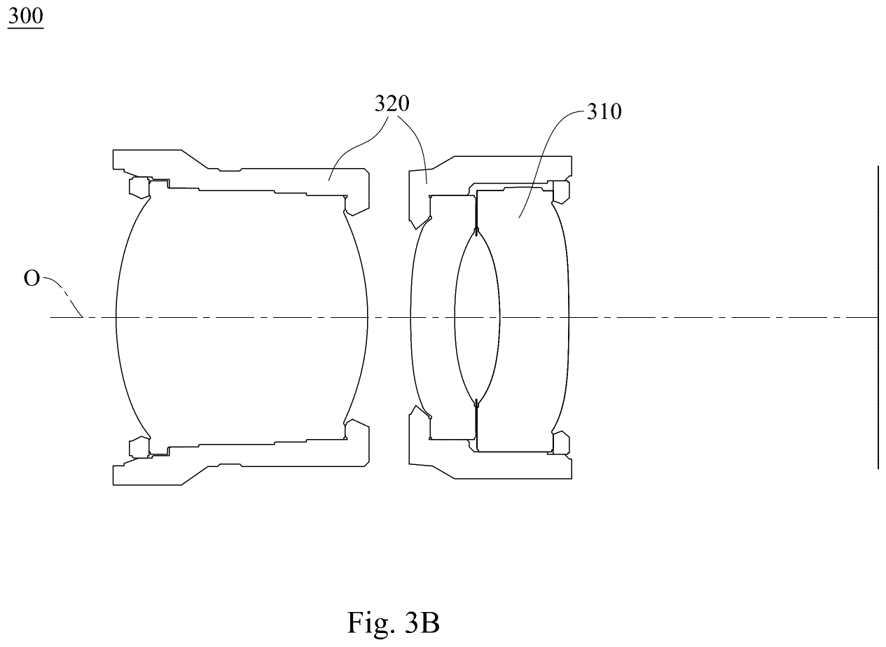

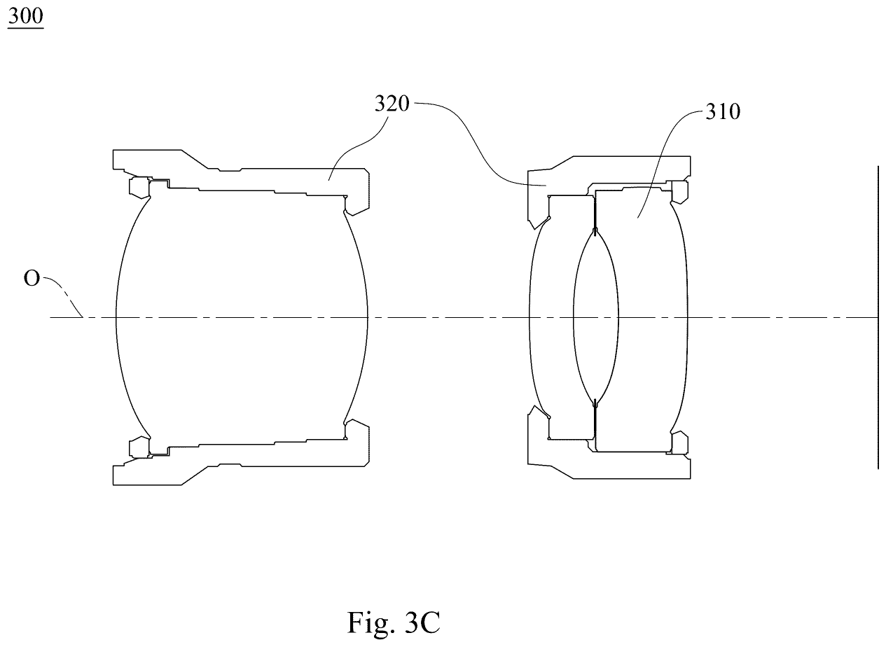

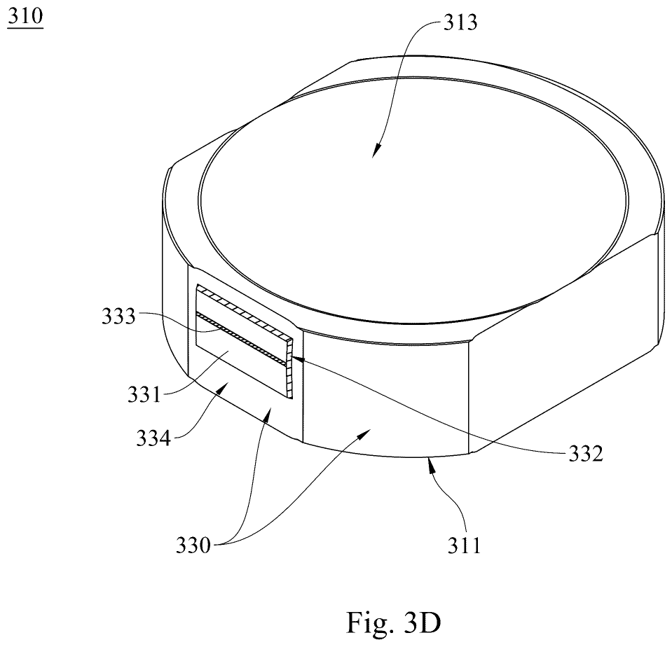

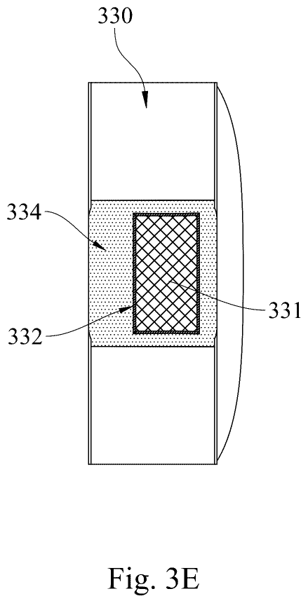

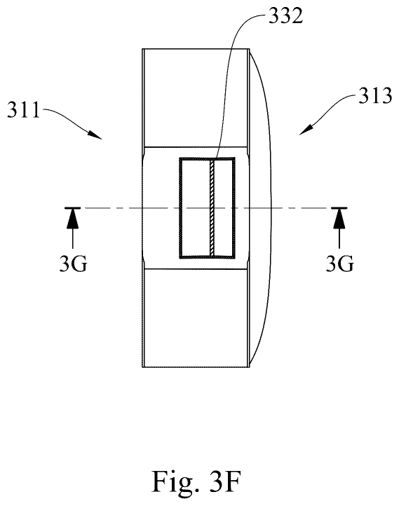

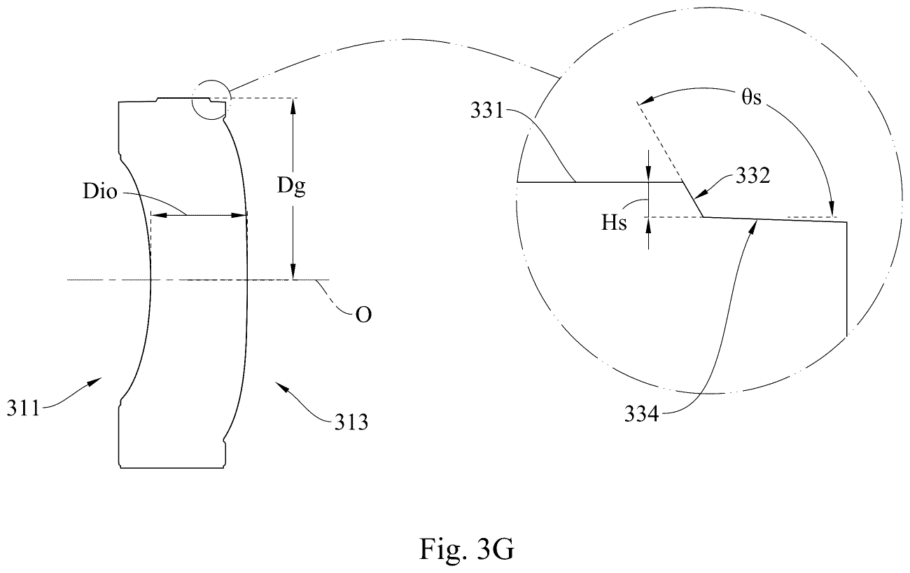

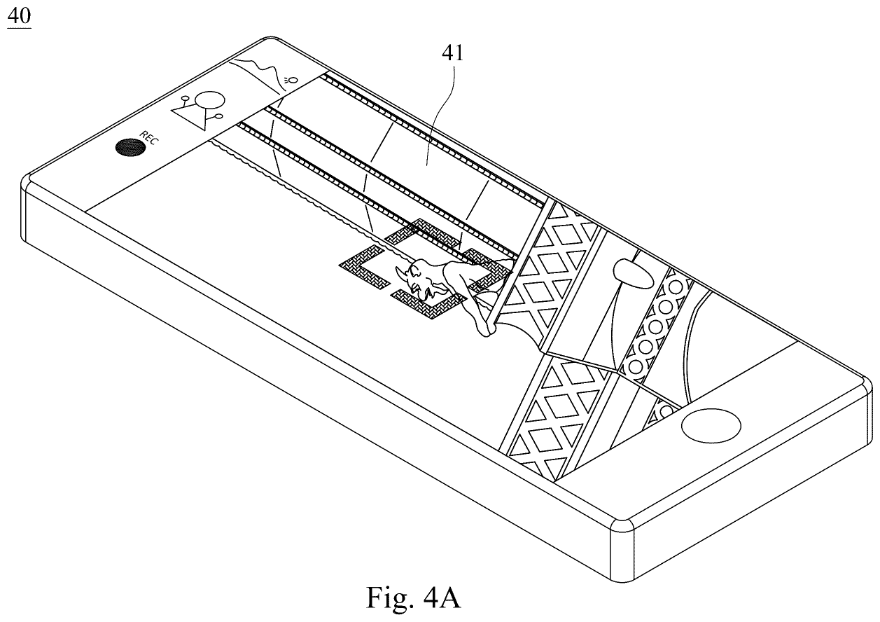

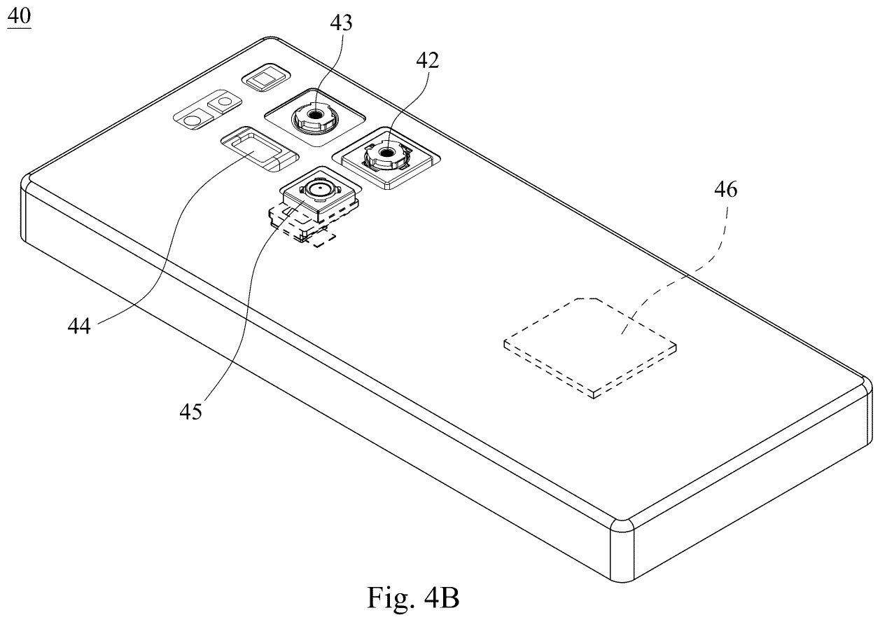

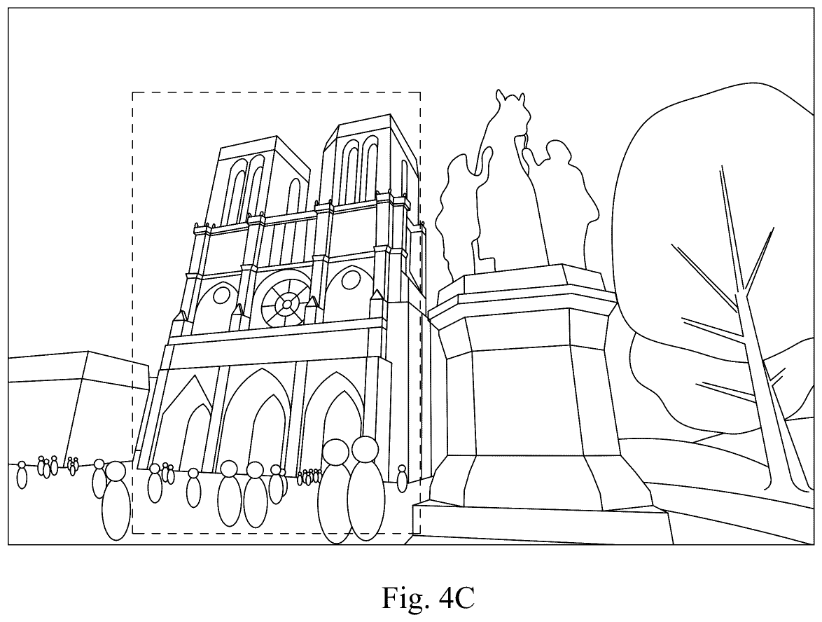

FIG. 1J is a partial enlarged view of a cross-section of the plastic optical element of the 5th Example according to the 1st Embodiment in FIG. 1B.

FIG. 1K is a partial enlarged view of a cross-section of the plastic optical element of the 6th Example according to the 1st Embodiment in FIG. 1B.

FIG. 1L is a schematic view of the plastic optical element of the imaging lens assembly according to the 1st Embodiment in FIG. 1A.

FIG. 1M is a schematic view of the incident surface of the plastic optical element according to the 1st Embodiment in FIG. 1L.

FIG. 1N is a partial top view of the irregular recesses of the plastic optical element according to the 1st Embodiment in FIG. 1B.

FIG. 1O is a cross-sectional view of the irregular recesses of the plastic optical element according to the 1st Embodiment in FIG. 1N.

FIG. 1P is a schematic view of the light blocking layer of the plastic optical element according to the 1st Embodiment in FIG. 1O.

FIG. 1Q is another schematic view of the light blocking layer of the plastic optical element according to the 1st Embodiment in FIG. 1O.

FIG. 1R is further another schematic view of the light blocking layer of the plastic optical element according to the 1st Embodiment in FIG. 1O.

FIG. 2A is a schematic view of an imaging lens assembly according to the 2nd Embodiment of the present disclosure.

FIG. 2B is a three-dimensional schematic view of the plastic optical element according to the 2nd Embodiment in FIG. 2A.

FIG. 2C is a schematic view of the connection surface of the plastic optical element according to the 2nd Embodiment in FIG. 2B.

FIG. 2D is a partial enlarged view of the reflection surface of the plastic optical element according to the 2nd Embodiment in FIG. 2B.

FIG. 2E is a schematic view of the incident surface and the exit surface of the plastic optical element according to the 2nd Embodiment in FIG. 2B.

FIG. 2F is a side view of the plastic optical element according to the 2nd Embodiment in FIG. 2B.

FIG. 3A is a three-dimensional schematic view of an imaging lens assembly according to the 3rd Embodiment of the present disclosure.

FIG. 3B is a schematic view of the imaging lens assembly according to the 3rd Embodiment in FIG. 3A.

FIG. 3C is another schematic view of the imaging lens assembly according to the 3rd Embodiment in FIG. 3A.

FIG. 3D is a three-dimensional schematic view of the plastic optical element according to the 3rd Embodiment in FIG. 3A.

FIG. 3E is a schematic view of the connection surface of the plastic optical element according to the 3rd Embodiment in FIG. 3D.

FIG. 3F is a side view of the plastic optical element according to the 3rd Embodiment in FIG. 3D.

FIG. 3G is a partial enlarged view of a cross-section of the plastic optical element along line 3G-3G according to the 3rd Embodiment in FIG. 3F.

FIG. 4A is a schematic view of an electronic device according to the 4th Embodiment of the present disclosure.

FIG. 4B is another schematic view of the electronic device according to the 4th Embodiment in FIG. 4A.

FIG. 4C is a schematic view of an image captured by the ultra-wide angle camera module of the electronic device according to the 4th Embodiment in FIG. 4B

FIG. 4D is a schematic view of an image captured by the high resolution camera module of the electronic device according to the 4th Embodiment in FIG. 4B

FIG. 4E is a schematic view of an image captured by the telephoto camera modules of the electronic device according to the 4th Embodiment in FIG. 4B.

FIG. 5 is a schematic view of an electronic device according to the 5th Embodiment of the present disclosure.

### DETAILED DESCRIPTION

The present disclosure provides an imaging lens assembly, including a plastic optical element. The plastic optical element includes an incident surface, an exit surface and at least one connection surface. An imaging light enters the plastic optical element through the incident surface and exits the plastic optical element through the exit surface. The connection surface is used to connect the incident surface and the exit surface, wherein the connection surface includes a gate vestige, a divergent nozzle surface and a cut vestige. The gate vestige is disposed on the connection surface, and the gate vestige is elevated relative to an adjacent portion of the connection surface. The divergent nozzle surface is connected to the gate vestige and the adjacent portion, and the divergent nozzle surface diverges and extends from the gate vestige toward a direction of the adjacent portion. The cut vestige is disposed on a surface of the gate vestige, wherein an outline of the cut vestige is linear, and the cut vestige extends across the surface of the gate vestige. When a projection along a direction in a front view of the adjacent portion of the connection surface, a projection area of the divergent nozzle surface is As, a projection area of the gate vestige is Ag, the following condition is satisfied: 0.08≤As/Ag≤0.68.

Furthermore, the plastic optical element can include a reflection surface. The imaging light can change a traveling direction through the reflection surface, and the connection surface can connect the incident surface, the reflection surface and the exit surface. Specifically, when the plastic optical element includes the incident surface, the reflection surface, the exit surface and the connection surface, the plastic optical element is a plastic prism; when the plastic optical element includes the incident surface, the exit surface and the connection surface, the plastic optical element is a plastic lens element.

Further, since the requirements of the plastic optical element for surface precision are increasing, the large area of the gate vestige is necessary to improve the molding quality. The gate vestige is the cut mark of the injection molded channel, it can also be called the flow mark, but it is not limited thereto. The surrounding of the conventional gate vestige has the vertical surfaces, which is not favorable for the light blocking process, and the large area of the gate vestige has the problems such as uneven cut surface, highly convex and easy to generate the stray light. Therefore, the imaging lens assembly of the present disclosure provided with the divergent nozzle surface is favorable for the subsequent light blocking process, such as laser roughening, coating, inking and other additional processes, thereby reducing the stray light generated around the gate vestige. Furthermore, the divergent nozzle surface also has the effect of adjusting the injection rate, which is favorable for improving the injection molded quality. The appropriate area ratio is favorable for balancing the forming quality and the imaging quality. Moreover, the cut vestige of the imaging lens assembly of the present disclosure is a mark left by cutting the injecting opening, which is the joint line when the two cutters are closed, and is favorable for improving the flatness and increasing the cutting yield of the injecting opening. The cut vestige and the adjacent gate vestige have different appearances. Specifically, they can be distinguished by the surface properties, such as a gloss, a color and a roughness. Furthermore, the projection area can be calculated by the image recognition. Since the surface properties and the inclination angles between the gate vestige, the divergent nozzle surface and the connection surface are different, both the gloss and the color may make the difference. Therefore, the area can be calculated, but the calculation method is not limited thereto, and the area can be calculated by measuring the surface contour.

When the projection along the direction in the front view of the adjacent portion of the connection surface, a projection area of the adjacent portion is Ac, the projection area of the divergent nozzle surface is As, the projection area of the gate vestige is Ag, the following condition can be satisfied: 0.48≤(As+Ag)/Ac≤3.8. Therefore, it is favorable for improving the forming quality by the large area ratio of the gate vestige and the divergent nozzle surface. Furthermore, the following conditions can be satisfied: 0.16≤As/Ag≤0.56; and 0.51≤(As+Ag)/Ac≤2.3.

The divergent nozzle surface can be disposed around the gate vestige. Therefore, it can be avoided from generating the stray light around the gate vestige.

When an angle formed between the divergent nozzle surface and the adjacent portion is θs, the following condition can be satisfied: 105 degrees≤θs≤160 degrees. Therefore, it is favorable for the additional light blocking process of the divergent nozzle surface. Furthermore, the following condition can be satisfied: 120 degrees≤θs≤150 degrees.

The imaging lens assembly defines an optical axis, when an extending distance of the optical axis between the incident surface and the exit surface is Dio, a perpendicular distance between the surface of the gate vestige and the optical axis is Dg, the following condition can be satisfied: 0.1≤Dg/Dio≤2.1. Therefore, it is favorable for the miniaturized design of the imaging lens assembly by the gate vestige of the plastic optical element close to the optical axis, and the longer extending distance of the optical axis is favorable for the design of the telephoto lens assembly. Furthermore, the following condition can be satisfied: 0.1≤Dg/Dio≤0.7.

The connection surface can further include a plurality of irregular recesses, and the irregular recesses are at least disposed on the surface of the gate vestige. Therefore, the surface of the gate vestige can be roughed by the laser process. Most of the irregular recesses have a width ranging from 1 μm to 100 μm, but it is not limited thereto. Minority of the irregular recesses may be close due to the laser path, so that the irregular recesses are merged to generate the larger width recesses, which is favorable to scatter the stray light.

A disposing range of the irregular recesses can further extend from the surface of the gate vestige to the divergent nozzle surface at a surrounding. Therefore, it can be avoided from reflecting the stray light around the gate vestige.

The plastic optical element can further include a light blocking layer for blocking a light from passing therethrough, and the light blocking layer is at least disposed on the gate vestige and the divergent nozzle surface. Therefore, it is favorable for reducing the reflectance, the gate vestige and the stray light generated around the gate vestige. Specifically, the light blocking layer can be a dark resin coating, a light-curing coating, a metal oxide coating, etc., but it is not limited thereto. The light blocking layer can also be disposed on at least one of the incident surface, the exit surface and the adjacent portion. Furthermore, a light pass aperture having a serrated profile can be formed by the pattern of the

A shape of the gate vestige can be a polygon, and the polygon has at least five edges. The polygon has a plurality of vertices, the cut vestige is a connecting line of two of the vertices, and the two of the vertices are not adjacent. Therefore, the cut vestige is the connecting line of two non-adjacent vertices, which is favorable for improving the cut quality of the injection molded channel. Furthermore, the gate vestige of the polygon is favorable for performing the image recognition and the light blocking process. Specifically, some of edges of the polygon also can be parallel to the surfaces having the optically functions, such as the incident surface, the exit surface and the reflection surface, which is favorable for improving the injection molded quality.

The present disclosure provides an imaging lens assembly, defining an optical axis and including a plastic optical element. The plastic optical element includes an incident surface, an exit surface and at least one connection surface. An imaging light enters the plastic optical element through the incident surface and exits the plastic optical element through the exit surface. The connection surface is used to connect the incident surface and the exit surface, wherein the connection surface includes a gate vestige, a divergent nozzle surface and a cut vestige. The gate vestige is disposed on the connection surface, and the gate vestige is elevated relative to an adjacent portion of the connection surface. The divergent nozzle surface is connected to the gate vestige and the adjacent portion, and the divergent nozzle surface diverges and extends from the gate vestige toward a direction of the adjacent portion. The cut vestige is disposed on a surface of the gate vestige, wherein an outline of the cut vestige is linear, and the cut vestige extends across the surface of the gate vestige. When an elevation height of the gate vestige relative to the adjacent portion is Hs, a perpendicular distance between the surface of the gate vestige and the optical axis is Dg, the following condition is satisfied: 0.02≤Hs/Dg≤0.12. Therefore, it can be avoided from affecting the optical surface when cutting the injecting opening by the appropriate elevation height ratio and the miniaturization design of the imaging lens assembly can be satisfied.

Furthermore, the plastic optical element can include a reflection surface. The imaging light can change a traveling direction through the reflection surface, and the connection surface can connect the incident surface, the reflection surface and the exit surface. Specifically, when the plastic optical element includes the incident surface, the reflection surface, the exit surface and the connection surface, the plastic optical element is a plastic prism; when the plastic optical element includes the incident surface, the exit surface and the connection surface, the plastic optical element is a plastic lens element.

Further, since the requirements of the plastic optical element for surface precision are increasing, the large area of the gate vestige is necessary to improve the molding quality. The gate vestige is the cut mark of the injection molded channel, it can also be called the flow mark, but it is not limited thereto. The surrounding of the conventional gate vestige have the vertical surfaces, which is not favorable for the light blocking process, and the large area of the gate vestige has the problems such as uneven cut surface, highly convex and easy to generate the stray light. Therefore, the imaging lens assembly of the present disclosure provided with the divergent nozzle surface is favorable for the subsequent light blocking process, such as laser roughening, coating, inking and other additional processes, thereby reducing the stray light generated around the gate vestige. Furthermore, the divergent nozzle surface also has the effect of adjusting the injection rate, which is favorable for improving the injection molded quality. Moreover, the cut vestige of the imaging lens assembly of the present disclosure is a mark left by cutting the injecting opening, which is the joint line when the two cutters are closed, and is favorable for improving the flatness and increasing the cutting yield of the injecting opening. The cut vestige and the adjacent gate vestige have different appearances. Specifically, they can be distinguished by the surface properties, such as a gloss, a color and a roughness.

When the elevation height of the gate vestige relative to the adjacent portion is Hs, the following condition can be satisfied: 0.08 mm≤Hs≤0.68 mm. Furthermore, the following condition can be satisfied: 0.12 mm≤Hs≤0.68 mm. Furthermore, the following condition can be satisfied: 0.14 mm≤Hs≤0.68 mm.

The divergent nozzle surface can be disposed around the gate vestige. Therefore, it can be avoided from generating the stray light around the gate vestige.

When an angle formed between the divergent nozzle surface and the adjacent portion is θs, the following condition can be satisfied: 105 degrees≤θs≤160 degrees. Therefore, it is favorable for the additional light blocking process of the divergent nozzle surface. Furthermore, the following condition can be satisfied: 120 degrees≤θs≤150 degrees.

When an extending distance of the optical axis between the incident surface and the exit surface is Dio, the perpendicular distance between the surface of the gate vestige and the optical axis is Dg, the following condition can be satisfied: 0.1≤Dg/Dio≤2.1. Therefore, it is favorable for the miniaturized design of the imaging lens assembly by the gate vestige of the plastic optical element close to the optical axis, and the longer extending distance of the optical axis is favorable for the design of the telephoto lens assembly. Furthermore, the following condition can be satisfied: 0.1≤Dg/Dio≤0.7.

The connection surface can further include a plurality of irregular recesses, and the irregular recesses are at least disposed on the surface of the gate vestige. Therefore, the surface of the gate vestige can be roughed by the laser process. Most of the irregular recesses have a width ranging from 1 μm to 100 μm, which is favorable to scatter the stray light.

A disposing range of the irregular recesses can further extend from the surface of the gate vestige to the divergent nozzle surface at a surrounding. Therefore, the stray light can be scattered to avoid the stray light from being reflected around the gate vestige.

The plastic optical element can further include a light blocking layer for blocking a light from passing therethrough, and the light blocking layer is at least disposed on the gate vestige and the divergent nozzle surface. Therefore, it is favorable for reducing the reflectance, the gate vestige and the stray light generated around the gate vestige. Specifically, the light blocking layer can be a dark resin coating, a light-curing coating, a metal oxide coating, etc., but it is not limited thereto. The light blocking layer can also be disposed on at least one of the incident surface, the exit surface and the adjacent portion. Furthermore, a light pass aperture having a serrated profile can be formed by the pattern of the

A shape of the gate vestige can be a polygon, and the polygon has at least five edges. The polygon has a plurality of vertices, the cut vestige is a connecting line of two of the vertices, and the two of the vertices are not adjacent. Therefore, the cut vestige is the connecting line of two non-adjacent vertices, which is favorable for improving the cut quality of the injection molded channel. Furthermore, the gate vestige of the polygon is favorable for performing the image recognition and the light blocking process. Specifically, some of edges of the polygon also can be parallel to the surfaces having the optically functions, such as the incident surface, the exit surface and the reflection surface, which is favorable for improving the injection molded quality.

The present disclosure provides an electronic device, which includes the aforementioned imaging lens assembly.

According to the aforementioned embodiment, specific embodiments and examples are provided, and illustrated via figures.

### 1st Embodiment

FIG. 1A is a schematic view of an imaging lens assembly 100 according to the 1st Embodiment of the present disclosure. In FIG. 1A, the imaging lens assembly 100 defines an optical axis O, and in order from an object side to an image side includes a plastic optical element 110 and an optical imaging lens assembly 120, wherein the plastic optical element 110 is a plastic prism.

FIG. 1B is a three-dimensional schematic view of the plastic optical element 110 according to the 1st Embodiment in FIG. 1A. FIG. 1C is a side view of the plastic optical element 110 according to the 1st Embodiment in FIG. 1B. FIG. 1D is a partial enlarged view of a cross-section of the plastic optical element 110 along line 1D-1D according to the 1st Embodiment in FIG. 1C. In FIG. 1B to FIG. 1D, the plastic optical element 110 includes an incident surface 111, a reflection surface 112, an exit surface 113 and at least one connection surface 130, wherein an imaging light (not shown in drawings) enters the plastic optical element 110 through the incident surface 111, changes a traveling direction through the reflection surface 112, and exits the plastic optical element 110 through the exit surface 113. The connection surface 130 is used to connect the incident surface 111, the reflection surface 112 and the exit surface 113, and includes a gate vestige 131, a divergent nozzle surface 132 and a cut vestige 133. The gate vestige 131 is disposed on the connection surface 130, and the gate vestige 131 is elevated relative to an adjacent portion 134 of the connection surface 130. The divergent nozzle surface 132 is connected to the gate vestige 131 and the adjacent portion 134, and the divergent nozzle surface 132 diverges and extends from the gate vestige 131 toward a direction of the adjacent portion 134 and is disposed around the gate vestige 131. The adjacent portion 134 is a portion of the connection surface 130 adjacent to the gate vestige 131 or the divergent nozzle surface 132. The cut vestige 133 is disposed on a surface of the gate vestige 131, wherein an outline of the cut vestige 133 is linear, and the cut vestige 133 extends across the surface of the gate vestige 131. Specifically, a shape of the gate vestige 131 is a polygon, the polygon has at least five edges and has a plurality of vertices 135, the cut vestige 133 is a connection line of two of the vertices 135, and the two of the vertices 135 are not adjacent.

In FIG. 1D, an elevation height of the gate vestige 131 relative to the adjacent portion 134 is Hs, an angle formed between the divergent nozzle surface 132 and the adjacent portion 134 is θs. Due to the connection surface 130 may have a draft angle, the elevation height Hs of the gate vestige 131 relative to the adjacent portion 134 may change depending on the different location, and the angle θs formed between the divergent nozzle surface 132 and the adjacent portion 134 also changes. Specifically, in FIG. 1D, Hs1 on the left side is 0.2 mm and θs is 130 degrees; Hs2 on the right side is 0.33 mm and θs is 131.5 degrees.

FIG. 1E is a schematic view of the connection surface 130 of the plastic optical element 110 according to the 1st Embodiment in FIG. 1B. In FIG. 1E, a projection along a direction in a front view of the adjacent portion 134 of the connection surface 130, a projection area of the adjacent portion 134 is Ac, a projection area of the divergent nozzle surface 132 is As, a projection area of the gate vestige 131 is Ag, an angle formed between the divergent nozzle surface 132 and the adjacent portion 134 is θs. The values of abovementioned parameters are shown in Table 1A.

TABLE 1A
1st Embodiment

| | | | |
|---|---|---|---|
| Ac (mm²) | 15.9 | θs | 130 degrees |
| As (mm²) | 3.76 | As/Ag | 0.23 |
| Ag (mm²) | 16.6 | (As + Ag)/Ac | 1.28 |

FIG. 1F is a schematic view of the connection surface 130 of the plastic optical element 110 of the 1st Example according to the 1st Embodiment in FIG. 1B. In FIG. 1F, a projection along a direction in a front view of the adjacent portion 134 of the connection surface 130, a projection area of the adjacent portion 134 is Ac, a projection area of the divergent nozzle surface 132 is As, a projection area of the gate vestige 131 is Ag, an angle formed between the divergent nozzle surface 132 and the adjacent portion 134 is es. The values of abovementioned parameters are shown in Table 1B.

TABLE 1B
1st Example of 1st Embodiment

| | | | |
|---|---|---|---|
| Ac (mm²) | 11.52 | θs | 150 degrees |
| As (mm²) | 8.14 | As/Ag | 0.49 |
| Ag (mm²) | 16.6 | (As + Ag)/Ac | 2.15 |

FIG. 1G is a schematic view of the connection surface 130 of the plastic optical element 110 of the 2nd Example according to the 1st Embodiment in FIG. 1B. In FIG. 1G, a projection along a direction in a front view of the adjacent portion 134 of the connection surface 130, a projection area of the adjacent portion 134 is Ac, a projection area of the divergent nozzle surface 132 is As, a projection area of the gate vestige 131 is Ag, an angle formed between the divergent nozzle surface 132 and the adjacent portion 134 is θs. The values of abovementioned parameters are shown in Table 1C.

TABLE 1C
2nd Example of 1st Embodiment

| | | | |
|---|---|---|---|
| Ac (mm²) | 18.08 | θs | 105 degrees |
| As (mm²) | 1.58 | As/Ag | 0.1 |
| Ag (mm²) | 16.6 | (As + Ag)/Ac | 1.01 |

FIG. 1H is a partial enlarged view of a cross-section of the plastic optical element 110 of the 3rd Example according to the 1st Embodiment in FIG. 1B. In FIG. 1H, the gate vestige 131 is elevated relative to the adjacent portion 134. The divergent nozzle surface 132 is connected to the gate vestige 131 and the adjacent portion 134, and diverges and extends from the gate vestige 131 toward a direction of the adjacent portion 134, wherein the divergent nozzle surface 132 is a concave arc surface.

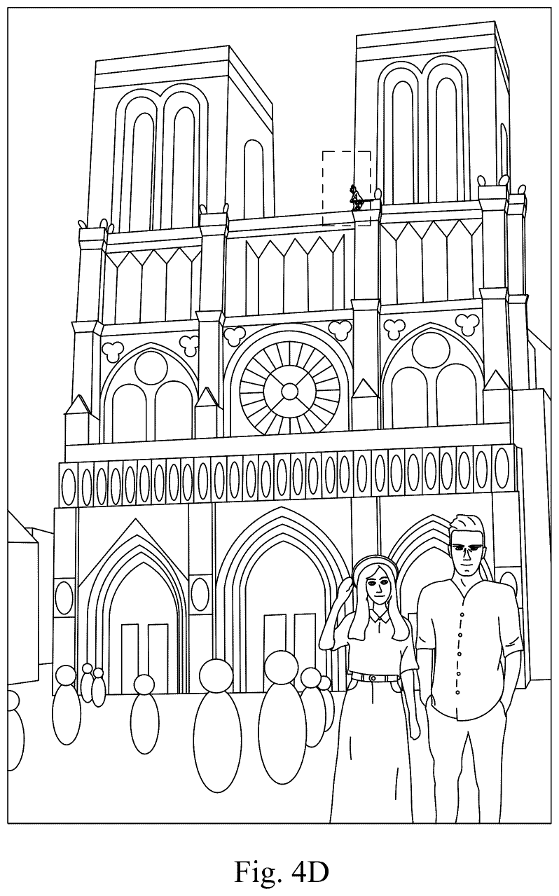

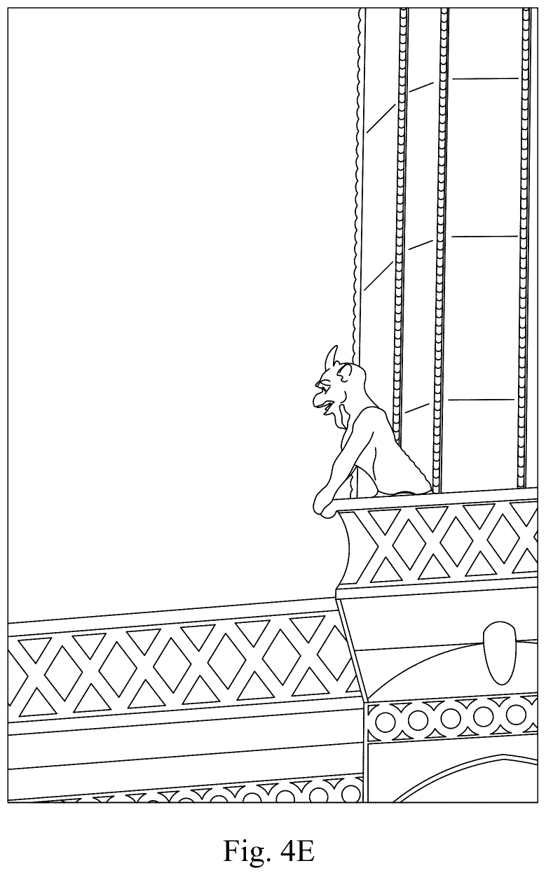

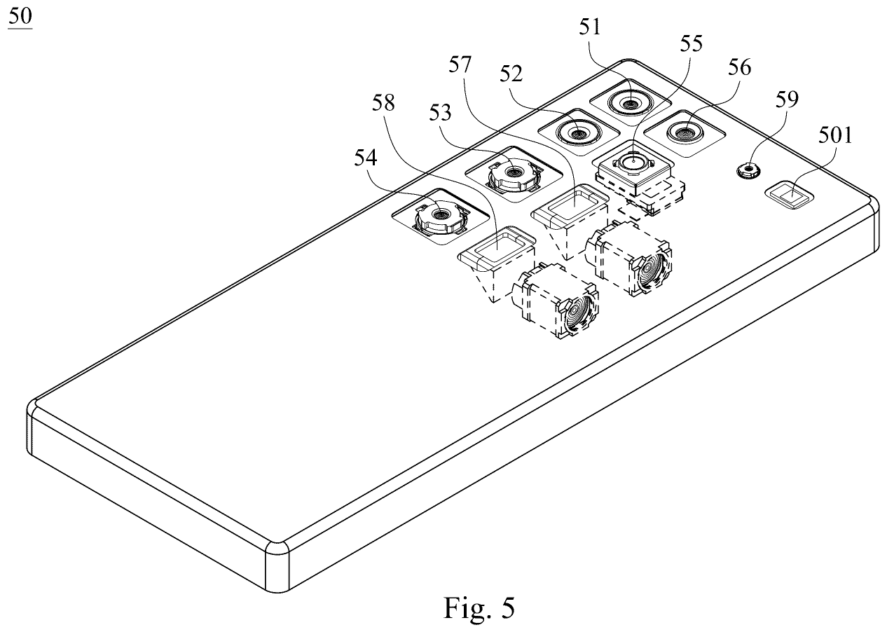

FIG. 11 is a partial enlarged view of a cross-section of the plastic optical element 110 of the 4th Example according to the 1st Embodiment in FIG. 1B. In FIG. 1I, the gate vestige 131 is elevated relative to the adjacent portion 134. The divergent nozzle surface 132 is connected to the gate vestige 131 and the adjacent portion 134, and diverges and extends from the gate vestige 131 toward a direction of the adjacent portion 134, wherein the divergent nozzle surface 132 is a convex arc surface.

FIG. 1J is a partial enlarged view of a cross-section of the plastic optical element 110 of the 5th Example according to the 1st Embodiment in FIG. 1B. In FIG. 1J, the gate vestige 131 is elevated relative to the adjacent portion 134. The divergent nozzle surface 132 is connected to the gate vestige 131 and the adjacent portion 134, and diverges and extends from the gate vestige 131 toward a direction of the adjacent portion 134, wherein the divergent nozzle surface 132 is a wave arc surface.

FIG. 1K is a partial enlarged view of a cross-section of the plastic optical element 110 of the 6th Example according to the 1st Embodiment in FIG. 1B. In FIG. 1K, the gate vestige 131 is elevated relative to the adjacent portion 134. The divergent nozzle surface 132 is connected to the gate vestige 131 and the adjacent portion 134, and diverges and extends from the gate vestige 131 toward a direction of the adjacent portion 134, wherein the divergent nozzle surface 132 is a stepped surface.

FIG. 1L is a schematic view of the plastic optical element 110 of the imaging lens assembly 100 according to the 1st Embodiment in FIG. 1A. FIG. 1M is a schematic view of the incident surface 111 of the plastic optical element 110 according to the 1st Embodiment in FIG. 1L. In FIG. 1D, FIG. 1L and FIG. 1M, an elevation height of the gate vestige 131 relative to the adjacent portion 134 is Hs, an extending distance of the optical axis O between the incident surface 111 and the exit surface 113 is Dio, a perpendicular distance between the surface of the gate vestige 131 and the optical axis O is Dg, wherein Hs is Hs1 and Hs2 depending on the different position respectively, and Dio is Dio1 and Dio2 depending on the different position respectively. The values of abovementioned parameters are shown in Table 1D.

TABLE 1D
1st Embodiment

| | | | |
|---|---|---|---|
| Dio1 (mm) | 4.36 | Hs2 (mm) | 0.33 |
| Dio2 (mm) | 4.36 | Dg/Dio | 0.61 |
| Dio (mm) | 8.72 | Hs1/Dg | 0.04 |
| Dg (mm) | 5.35 | Hs2/Dg | 0.06 |
| Hs1 (mm) | 0.2 | | |

FIG. 1N is a partial top view of the irregular recesses 140 of the plastic optical element 110 according to the 1st Embodiment in FIG. 1B. FIG. 1O is a cross-sectional view of the irregular recesses 140 of the plastic optical element 110 according to the 1st Embodiment in FIG. 1N. In FIG. 1N, the connection surface 130 of the plastic optical element 110 includes a plurality of irregular recesses 140 (dot-shaped areas), and the irregular recesses 140 are at least disposed on the surface of the gate vestige 131, wherein a disposing range of the irregular recesses 140 further extends from the surface of the gate vestige 131 to the divergent nozzle surface 132 at a surrounding. Furthermore, in FIG. 1O, the degree of undulation of the irregular recesses 140 can be adjusted according the requirement, and the irregular recesses 140 with different morphologies can be formed by adjusting parameters, such as the laser intensity and the dot matrix laser path.

FIG. 1P is a schematic view of the light blocking layer 150 of the plastic optical element 110 according to the 1st Embodiment in FIG. 1O. FIG. 1Q is another schematic view of the light blocking layer 150 of the plastic optical element 110 according to the 1st Embodiment in FIG. 1O. FIG. 1R is further another schematic view of the light blocking layer 150 of the plastic optical element 110 according to the 1st Embodiment in FIG. 1O. In FIG. 1P, the plastic optical element 110 further includes a light blocking layer 150 for blocking a light (not shown in drawings) from passing therethrough, and the light blocking layer 150 is at least disposed on the gate vestige 131 and the divergent nozzle surface 132. Specifically, the light blocking layer 150 can be disposed on the surface of the irregular recesses 140, which is favorable for reducing the reflectivity and avoiding the gate vestige 131 from generating the stray light. In FIG. 1Q, if the thickness of the light blocking layer 150 increasing, the outer surface contour of the irregular recesses 140 will become non-obviously, at this time, the inner surface of the irregular recesses 140 can be observed from the incident surface 111 or the exit surface 113. In FIG. 1R, the light blocking layer 150 can be further disposed on at least one of the incident surface 111 and the exit surface 113, and a light pass aperture having a serrated profile can be formed by the pattern of the light blocking layer 150, which is favorable for eliminating the stray light.

### 2nd Embodiment

FIG. 2A is a schematic view of an imaging lens assembly 200 according to the 2nd Embodiment of the present disclosure. In FIG. 2A, the imaging lens assembly 200 defines an optical axis O, and in order from an object side to an image side includes at least one optical imaging lens assembly 220 and a plastic optical element 210, wherein the plastic optical element 210 is a plastic prism.

FIG. 2B is a three-dimensional schematic view of the plastic optical element 210 according to the 2nd Embodiment in FIG. 2A. In FIG. 2B, the plastic optical element 210 includes an incident surface 211, at least one reflection surface 212, an exit surface 213 and at least one connection surface 230, wherein an imaging light (not shown in drawings) enters the plastic optical element 210 through the incident surface 211, changes a traveling direction through the reflection surface 212, and exits the plastic optical element 210 through the exit surface 213. The connection surface 230 is used to connect the incident surface 211, the reflection surface 212 and the exit surface 213, and includes a gate vestige 231, a divergent nozzle surface 232 and a cut vestige 233. The gate vestige 231 is disposed on the connection surface 230, and the gate vestige 231 is elevated relative to an adjacent portion 234 of the connection surface 230. The divergent nozzle surface 232 is connected to the gate vestige 231 and the adjacent portion 234, and the divergent nozzle surface 232 diverges and extends from the gate vestige 231 toward a direction of the adjacent portion 234 and is disposed around the gate vestige 231. The adjacent portion 234 is a portion of the connection surface 230 adjacent to the gate vestige 231 or the divergent nozzle surface 232. The cut vestige 233 is disposed on a surface of the gate vestige 231, wherein an outline of the cut vestige 233 is linear, and the cut vestige 233 extends across the surface of the gate vestige 231.

FIG. 2C is a schematic view of the connection surface 230 of the plastic optical element 210 according to the 2nd Embodiment in FIG. 2B. FIG. 2D is a partial enlarged view of the reflection surface 212 of the plastic optical element 210 according to the 2nd Embodiment in FIG. 2B. FIG. 2E is a schematic view of the incident surface 211 and the exit surface 213 of the plastic optical element 210 according to the 2nd Embodiment in FIG. 2B. FIG. 2F is a side view of the plastic optical element 210 according to the 2nd Embodiment in FIG. 2B. In FIG. 2C to FIG. 2F, a projection along a direction in a front view of the adjacent portion 234 of the connection surface 230, a projection area of the adjacent portion 234 is Ac, a projection area of the divergent nozzle surface 232 is As, a projection area of the gate vestige 231 is Ag, an angle formed between the divergent nozzle surface 232 and the adjacent portion 234 is θs, an elevation height of the gate vestige 231 relative to the adjacent portion 234 is Hs, an extending distance of the optical axis O between the incident surface 211 and the exit surface 213 is Dio, a perpendicular distance between the surface of the gate vestige 231 and the optical axis O is Dg, wherein Dio is Dio1, Dio2, Dio3 and Dio4 depending on the different position respectively. The values of abovementioned parameters are shown in Table 2A.

TABLE 2A
2nd Embodiment

| | | | |
|---|---|---|---|
| Ac (mm²) | 11.27 | Dio1 (mm) | 1.73 |
| As (mm²) | 0.6 | Dio2 (mm) | 4.65 |
| Ag (mm²) | 1.12 | Dio3 (mm) | 4.65 |
| As/Ag | 0.54 | Dio4 (mm) | 1.73 |
| (As + Ag)/Ac | 0.15 | Dio (mm) | 12.76 |
| θs | 142 degrees | Dg/Dio | 0.34 |
| Hs (mm) | 0.15 | Hs/Dg | 0.03 |
| Dg (mm) | 4.36 | | |

### 3rd Embodiment

FIG. 3A is a three-dimensional schematic view of an imaging lens assembly 300 according to the 3rd Embodiment of the present disclosure. FIG. 3B is a schematic view of the imaging lens assembly 300 according to the 3rd Embodiment in FIG. 3A. FIG. 3C is another schematic view of the imaging lens assembly 300 according to the 3rd Embodiment in FIG. 3A. In FIG. 3A to FIG. 3C, the imaging lens assembly 300 defines an optical axis O, and in order from an object side to an image side includes two optical imaging lens assemblies 320 and a plastic optical element 310, wherein the plastic optical element 310 is a plastic lens element. Furthermore, the two optical imaging lens assemblies 320 of the imaging lens assembly 300 can move relative to each other to achieve the function of changing the focal length.

FIG. 3D is a three-dimensional schematic view of the plastic optical element 310 according to the 3rd Embodiment in FIG. 3A. In FIG. 3D, the plastic optical element 310 includes an incident surface 311, an exit surface 313 and at least one connection surface 330, wherein an imaging light (not shown in drawings) enters the plastic optical element 310 through the incident surface 311, and exits the plastic optical element 310 through the exit surface 313. The connection surface 330 is used to connect the incident surface 311 and the exit surface 313, and includes a gate vestige 331, a divergent nozzle surface 332 and a cut vestige 333. The gate vestige 331 is disposed on the connection surface 330, and the gate vestige 331 is elevated relative to an adjacent portion 334 of the connection surface 330, wherein the connection surface 330 where the gate vestige 331 located is closer to the optical axis O than the other connection surfaces 330, it can be avoided the gate vestige 331 from interfering with other components of the imaging lens assembly 300. The divergent nozzle surface 332 is connected to the gate vestige 331 and the adjacent portion 334, and the divergent nozzle surface 332 diverges and extends from the gate vestige 331 toward a direction of the adjacent portion 334 and is disposed around the gate vestige 331. The adjacent portion 334 is a portion of the connection surface 330 adjacent to the gate vestige 331 or the divergent nozzle surface 332. The cut vestige 333 is disposed on a surface of the gate vestige 331, wherein an outline of the cut vestige 333 is linear, and the cut vestige 333 extends across the surface of the gate vestige 331.

FIG. 3E is a schematic view of the connection surface 330 of the plastic optical element 310 according to the 3rd Embodiment in FIG. 3D. FIG. 3F is a side view of the plastic optical element 310 according to the 3rd Embodiment in FIG. 3D. FIG. 3G is a partial enlarged view of a cross-section of the plastic optical element 310 along line 3G-3G according to the 3rd Embodiment in FIG. 3F. In FIG. 3E to FIG. 3G, a projection along a direction in a front view of the adjacent portion 334 of the connection surface 330, a projection area of the adjacent portion 334 is Ac, a projection area of the divergent nozzle surface 332 is As, a projection area of the gate vestige 331 is Ag, an angle formed between the divergent nozzle surface 332 and the adjacent portion 334 is θs, an elevation height of the gate vestige 331 relative to the adjacent portion 334 is Hs, an extending distance of the optical axis O between the incident surface 311 and the exit surface 313 is Dio, a perpendicular distance between the surface of the gate vestige 331 and the optical axis O is Dg. The values of abovementioned parameters are shown in Table 3A.

TABLE 3A
3rd Embodiment

| | | | |
|---|---|---|---|
| Ac (mm²) | 1.6 | Hs (mm) | 0.1 |
| As (mm²) | 0.13 | Dg (mm) | 2.67 |
| Ag (mm²) | 1.08 | Dio (mm) | 1.41 |
| As/Ag | 0.12 | Dg/Dio | 1.89 |
| (As + Ag)/Ac | 0.76 | Hs/Dg | 0.04 |
| θs | 120 degrees | | |

### 4th Embodiment

FIG. 4A is a schematic view of an electronic device 40 according to the 4th Embodiment of the present disclosure. FIG. 4B is another schematic view of the electronic device 40 according to the 4th Embodiment in FIG. 4A. In FIG. 4A and FIG. 4B, the electronic device 40 is a smart phone, and includes a plurality of camera modules (not shown in drawings) and a user interface 41, wherein each of the camera modules can be one of the imaging lens assemblies according to the aforementioned 1st Embodiment to 3rd Embodiment, but the present disclosure is not limited thereto. Furthermore, the camera modules include an ultra-wide angle camera module 42, a high resolution camera module 43 and telephoto camera modules 44, 45, and the user interface 41 is a touch screen, which is not limited thereto.

Furthermore, users enter a shooting mode via the user interface 41, wherein the user interface 41 is for displaying the scene, and the shooting angle can be manually adjusted to switch the different camera modules. At this moment, the imaging light is gathered on the image sensor via the camera module, and an electronic signal about an image is output to an image signal processor (ISP) 46.

In FIG. 4B, to meet a specification of the electronic device 40, the electronic device 40 can further include an optical anti-shake mechanism (not shown in drawings). Furthermore, the electronic device 40 can further include at least one focusing assisting module (not shown in drawings) and at least one sensing element (not shown in drawings). The focusing assisting module can be a flash module for compensating a color temperature, an infrared distance measurement component, a laser focus module, etc. The sensing element can have functions for sensing physical momentum and kinetic energy, such as an accelerator, a gyroscope, a Hall Effect Element, to sense shaking or jitters applied by hands of the user or external environments. Accordingly, the camera module in the electronic device 40 equipped with an auto-focusing mechanism and the optical anti-shake mechanism can be enhanced to achieve the superior image quality. Furthermore, the electronic device 40 according to the present disclosure can have a capturing function with multiple modes, such as taking optimized selfies, high dynamic range (HDR) under a low light condition, 4K resolution recording, etc. Furthermore, the users can visually see a captured image of the camera through the user interface 41 and manually operate the view finding range on the user interface 41 to achieve the auto-focus function of what you see is what you get.

Moreover, the camera module, the optical anti-shake mechanism, the sensing element and the focusing assisting module can be disposed on a flexible printed circuit board (FPC) (not shown in drawings) and electrically connected to the associated components, such as the image signal processor 46, via a connector (not shown in drawings) to perform a capturing process. Since the current electronic devices, such as smart phones, have a tendency of being compact, the way of firstly disposing the camera module and related components on the flexible printed circuit board and secondly integrating the circuit thereof into the main board of the electronic device via the connector can satisfy the requirements of the mechanical design and the circuit layout of the limited space inside the electronic device, and obtain more margins. The autofocus function of the camera module can also be controlled more flexibly via the touch screen of the electronic device. According to the 4th Embodiment, the electronic device 40 can include a plurality of sensing elements and a plurality of focusing assisting modules. The sensing elements and the focusing assisting modules are disposed on the flexible printed circuit board and at least one other flexible printed circuit board (not shown in drawings) and electrically connected to the associated components, such as the image signal processor 46, via corresponding connectors to perform the capturing process. In other examples (not shown in drawings), the sensing elements and the focusing assisting modules can also be disposed on the main board of the electronic device or carrier boards of other types according to requirements of the mechanical design and the circuit layout.

Furthermore, the electronic device 40 can further include, but not be limited to, a display, a control unit, a storage unit, a random access memory (RAW), a read-only memory (ROM), or the combination thereof.

FIG. 4C is a schematic view of an image captured by the ultra-wide angle camera module 42 of the electronic device 40 according to the 4th Embodiment in FIG. 4B. In FIG. 4C, the larger range of the image can be captured via the ultra-wide angle camera module 42, and the ultra-wide angle camera module 42 can have the function of accommodating more wide range of the scene.

FIG. 4D is a schematic view of an image captured by the high resolution camera module 43 of the electronic device 40 according to the 4th Embodiment in FIG. 4B. In FIG. 4D, the image of the certain range with the high resolution can be captured via the high resolution camera module 43, and the high resolution camera module 43 has the function of the high resolution and the low deformation.

FIG. 4E is a schematic view of an image captured by the telephoto camera modules 44, 45 of the electronic device 40 according to the 4th Embodiment in FIG. 4B. In FIG. 4E, the telephoto camera modules 44, 45 have the enlarging function of the high magnification, and the distant image can be captured and enlarged with high magnification via the telephoto camera modules 44, 45.

In FIG. 4C to FIG. 4E, the zooming function can be obtained via the electronic device 40, when the scene is captured via the camera module with different focal lengths cooperated with the function of image processing.

### 5th Embodiment

FIG. 5 is a schematic view of an electronic device 50 according to the 5th Embodiment of the present disclosure. In FIG. 5, the electronic device 50 is a smart phone, and includes a camera module, wherein the camera module can include one of the imaging lens assemblies according to the aforementioned 1st Embodiment to 3rd Embodiment, but the present disclosure is not limited thereto. Furthermore, the camera module includes ultra-wide angle camera modules 51, 52, wide angle camera modules 53, 54, telephoto camera modules 55, 56, 57, 58 and a Time-Of-Flight (TOF) module 59. The TOF module 59 can be another type of the camera module, and the disposition is not limited thereto. Further, the telephoto camera modules 57, 58 further have the function of folding the light path, but the present disclosure is not limited thereto.

To meet a specification of the electronic device 50, the electronic device 50 can further include an optical anti-shake mechanism (not shown in drawings). Furthermore, the electronic device 50 can further include at least one focusing assisting module (not shown in drawings) and at least one sensing element (not shown in drawings). The focusing assisting module can be a flash module 501 for compensating a color temperature, and an infrared distance measurement component, a laser focus module, etc. The sensing element can have functions for sensing physical momentum and kinetic energy, such as an accelerator, a gyroscope, a Hall Effect Element, to sense shaking or jitters applied by hands of the user or external environments. Accordingly, the camera module in the electronic device 50 equipped with an auto-focusing mechanism and the optical anti-shake mechanism can be enhanced to achieve the superior image quality. Furthermore, the electronic device 50 according to the present disclosure can have a capturing function with multiple modes, such as taking optimized selfies, High Dynamic Range (HDR) under a low light condition, 4K Resolution recording, etc.

Further, all of other structures and dispositions according to the 5th Embodiment are the same as the structures and the dispositions according to the 4th Embodiment, and will not be described again herein.

The foregoing description, for purpose of explanation, has been described with reference to specific embodiments. It is to be noted that Tables show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. An imaging lens assembly, comprising:
a plastic optical element, comprising:
an incident surface, wherein an imaging light enters the plastic optical element through the incident surface;
a reflection surface, wherein the imaging light changes a traveling direction through the reflection surface;
an exit surface, wherein the imaging light exits the plastic optical element through the exit surface; and
at least one connection surface used to connect the incident surface, the reflection surface and the exit surface, wherein the at least one connection surface comprises:
a gate vestige disposed on the at least one connection surface, and the gate vestige elevated relative to an adjacent portion of the at least one connection surface;
a divergent nozzle surface connected to the gate vestige and the adjacent portion, and the divergent nozzle surface diverging and extending from the gate vestige toward a direction of the adjacent portion; and
a cut vestige disposed on a surface of the gate vestige, wherein an outline of the cut vestige is linear, and the cut vestige extends across the surface of the gate vestige;
wherein a projection along a direction in a front view of the adjacent portion of the at least one connection surface, a projection area of the divergent nozzle surface is As, a projection area of the gate vestige is Ag, and the following condition is satisfied:
$$0.08 \leq As / Ag \leq 0.6 8 .$$

2. The imaging lens assembly of claim 1, wherein the projection along the direction in the front view of the adjacent portion of the at least one connection surface, a projection area of the adjacent portion is Ac, the projection area of the divergent nozzle surface is As, the projection area of the gate vestige is Ag, and the following condition is satisfied:
$$0.48 \leq ( As + Ag ) / Ac \leq 3.8 .$$

3. The imaging lens assembly of claim 2, wherein the projection along the direction in the front view of the adjacent portion of the at least one connection surface, the projection area of the adjacent portion is Ac, the projection area of the divergent nozzle surface is As, the projection area of the gate vestige is Ag, and the following conditions are satisfied:
$$0.16 \leq As / Ag \leq 0.56 ; and$$
$$0.51 \leq ( As + Ag ) / Ac \leq 2. 3 .$$

4. The imaging lens assembly of claim 1, wherein the divergent nozzle surface is disposed around the gate vestige.

5. The imaging lens assembly of claim 1, wherein an angle formed between the divergent nozzle surface and the adjacent portion is es, and the following condition is satisfied:
$$105 degrees \leq θ s \leq 160 degrees .$$

6. The imaging lens assembly of claim 5, wherein the angle formed between the divergent nozzle surface and the adjacent portion is θs, and the following condition is satisfied:
$$120 degrees \leq θ s \leq 150 degrees .$$

7. The imaging lens assembly of claim 1, wherein the imaging lens assembly defines an optical axis, an extending distance of the optical axis between the incident surface and the exit surface is Dio, a perpendicular distance between the surface of the gate vestige and the optical axis is Dg, and the following condition is satisfied:
$$0.1 \leq Dg / Dio \leq 2.1 .$$

8. The imaging lens assembly of claim 7, wherein the extending distance of the optical axis between the incident surface and the exit surface is Dio, the perpendicular distance between the surface of the gate vestige and the optical axis is Dg, and the following condition is satisfied:
$$0.1 \leq Dg / Dio \leq 0.7 .$$

9. The imaging lens assembly of claim 1, wherein the at least one connection surface further comprises a plurality of irregular recesses, the irregular recesses are at least disposed on the surface of the gate vestige.

10. The imaging lens assembly of claim 9, wherein a disposing range of the irregular recesses further extends from the surface of the gate vestige to the divergent nozzle surface at a surrounding.

11. The imaging lens assembly of claim 1, wherein the plastic optical element further comprises a light blocking layer for blocking a light from passing therethrough, and the light blocking layer is at least disposed on the gate vestige and the divergent nozzle surface.

12. The imaging lens assembly of claim 1, wherein a shape of the gate vestige is a polygon, the polygon has at least five edges, the polygon has a plurality of vertices, the cut vestige is a connecting line of two of the vertices, and the two of the vertices are not adjacent.

13. An imaging lens assembly, defining an optical axis and comprising:
a plastic optical element, comprising:
an incident surface, wherein an imaging light enters the plastic optical element through the incident surface;
a reflection surface, wherein the imaging light changes a traveling direction through the reflection surface;
an exit surface, wherein the imaging light exits the plastic optical element through the exit surface; and
at least one connection surface used to connect the incident surface, the reflection surface and the exit surface, wherein the at least one connection surface comprises:
a gate vestige disposed on the at least one connection surface, and the gate vestige elevated relative to an adjacent portion of the at least one connection surface;
a divergent nozzle surface connected to the gate vestige and the adjacent portion, and the divergent nozzle surface diverging and extending from the gate vestige toward a direction of the adjacent portion; and
a cut vestige disposed on a surface of the gate vestige, wherein an outline of the cut vestige is linear, and the cut vestige extends across the surface of the gate vestige;
wherein an elevation height of the gate vestige relative to the adjacent portion is Hs, a perpendicular distance between the surface of the gate vestige and the optical axis is Dg, and the following condition is satisfied:
$$0.02 \leq Hs / Dq \leq 0.12 .$$

14. The imaging lens assembly of claim 13, wherein the elevation height of the gate vestige relative to the adjacent portion is Hs, and the following condition is satisfied:
$$0.14 mm \leq Hs \leq 0.68 mm .$$

15. The imaging lens assembly of claim 13, wherein the divergent nozzle surface is disposed around the gate vestige.

16. The imaging lens assembly of claim 13, wherein an angle formed between the divergent nozzle surface and the adjacent portion is θs, and the following condition is satisfied:
$$105 degrees \leq θ s \leq 160 degrees .$$

17. The imaging lens assembly of claim 16, wherein the angle formed between the divergent nozzle surface and the adjacent portion is θs, and the following condition is satisfied:
$$120 degrees \leq θ s \leq 150 degrees .$$

18. The imaging lens assembly of claim 13, wherein an extending distance of the optical axis between the incident surface and the exit surface is Dio, the perpendicular distance between the surface of the gate vestige and the optical axis is Dg, and the following condition is satisfied:
$$0.1 \leq Dg / Dio \leq 0.7 .$$

19. The imaging lens assembly of claim 13, wherein the at least one connection surface further comprises a plurality of irregular recesses, the irregular recesses are at least disposed on the surface of the gate vestige.

20. The imaging lens assembly of claim 19, wherein a disposing range of the irregular recesses further extends from the surface of the gate vestige to the divergent nozzle surface at a surrounding.

21. The imaging lens assembly of claim 13, wherein the plastic optical element further comprises a light blocking layer for blocking a light from passing therethrough, and the light blocking layer is at least disposed on the gate vestige and the divergent nozzle surface.

22. The imaging lens assembly of claim 13, wherein a shape of the gate vestige is a polygon, the polygon has at least five edges, the polygon has a plurality of vertices, the cut vestige is a connecting line of two of the vertices, and the two of the vertices are not adjacent.

23. An imaging lens assembly, comprising:
a plastic optical element, comprising:
an incident surface, wherein an imaging light enters the plastic optical element through the incident surface;
an exit surface, wherein the imaging light exits the plastic optical element through the exit surface; and
at least one connection surface used to connect the incident surface and the exit surface, wherein the at least one connection surface comprises:
a gate vestige disposed on the at least one connection surface, and the gate vestige elevated relative to an adjacent portion of the at least one connection surface;
a divergent nozzle surface connected to the gate vestige and the adjacent portion, and the divergent nozzle surface diverging and extending from the gate vestige toward a direction of the adjacent portion; and
a cut vestige disposed on a surface of the gate vestige, wherein an outline of the cut vestige is linear, and the cut vestige extends across the surface of the gate vestige;
wherein a projection along a direction in a front view of the adjacent portion of the at least one connection surface, a projection area of the divergent nozzle surface is As, a projection area of the gate vestige is Ag, and the following condition is satisfied:
$$0.08 \leq As / Ag \leq 0.68 .$$

24. The imaging lens assembly of claim 23, wherein the projection along the direction in the front view of the adjacent portion of the at least one connection surface, a projection area of the adjacent portion is Ac, the projection area of the divergent nozzle surface is As, the projection area of the gate vestige is Ag, and the following condition is satisfied:
$$0.48 \leq ( A s + Ag ) / Ac \leq 3.8 .$$

25. The imaging lens assembly of claim 24, wherein the projection along the direction in the front view of the adjacent portion of the at least one connection surface, the projection area of the adjacent portion is Ac, the projection area of the divergent nozzle surface is As, the projection area of the gate vestige is Ag, and the following conditions are satisfied:
$$0.16 \leq As / Ag \leq 0.56 ;$$
$$and$$
$$0.51 \leq ( A s + Ag ) / Ac \leq 2.3 .$$

26. The imaging lens assembly of claim 23, wherein the divergent nozzle surface is disposed around the gate vestige.

27. The imaging lens assembly of claim 23, wherein an angle formed between the divergent nozzle surface and the adjacent portion is θs, and the following condition is satisfied:
$$105 degrees \leq θ s \leq 160 degrees .$$

28. The imaging lens assembly of claim 27, wherein the angle formed between the divergent nozzle surface and the adjacent portion is θs, and the following condition is satisfied:
$$120 degrees \leq θ s \leq 150 degrees .$$

29. The imaging lens assembly of claim 23, wherein the imaging lens assembly defines an optical axis, an extending distance of the optical axis between the incident surface and the exit surface is Dio, a perpendicular distance between the surface of the gate vestige and the optical axis is Dg, and the following condition is satisfied:
$$0.1 \leq Dg / Dio \leq 2.1 .$$

30. The imaging lens assembly of claim 23, wherein the at least one connection surface further comprises a plurality of irregular recesses, the irregular recesses are at least disposed on the surface of the gate vestige.

31. The imaging lens assembly of claim 30, wherein a disposing range of the irregular recesses further extends from the surface of the gate vestige to the divergent nozzle surface at a surrounding.

32. The imaging lens assembly of claim 23, wherein the plastic optical element further comprises a light blocking layer for blocking a light from passing therethrough, and the light blocking layer is at least disposed on the gate vestige and the divergent nozzle surface.

33. An imaging lens assembly, defining an optical axis and comprising:
a plastic optical element, comprising:
an incident surface, wherein an imaging light enters the plastic optical element through the incident surface;
an exit surface, wherein the imaging light exits the plastic optical element through the exit surface; and
at least one connection surface used to connect the incident surface and the exit surface, wherein the at least one connection surface comprises:
a gate vestige disposed on the at least one connection surface, and the gate vestige elevated relative to an adjacent portion of the at least one connection surface;
a divergent nozzle surface connected to the gate vestige and the adjacent portion, and the divergent nozzle surface diverging and extending from the gate vestige toward a direction of the adjacent portion; and
a cut vestige disposed on a surface of the gate vestige, wherein an outline of the cut vestige is linear, and the cut vestige extends across the surface of the gate vestige;
wherein an elevation height of the gate vestige relative to the adjacent portion is Hs, a perpendicular distance between the surface of the gate vestige and the optical axis is Dg, and the following condition is satisfied:
$$0.02 \leq Hs / Dg \leq 0.12 .$$

34. The imaging lens assembly of claim 33, wherein the elevation height of the gate vestige relative to the adjacent portion is Hs, and the following condition is satisfied:
$$0.08 mm \leq Hs \leq 0.68 mm .$$

35. The imaging lens assembly of claim 33, wherein the divergent nozzle surface is disposed around the gate vestige.

36. The imaging lens assembly of claim 33, wherein an angle formed between the divergent nozzle surface and the adjacent portion is θs, and the following condition is satisfied:
$$105 degrees \leq θ s \leq 160 degrees .$$

37. The imaging lens assembly of claim 36, wherein the angle formed between the divergent nozzle surface and the adjacent portion is es, and the following condition is satisfied:
$$120 degrees \leq θ s \leq 150 degrees .$$

38. The imaging lens assembly of claim 33, wherein an extending distance of the optical axis between the incident surface and the exit surface is Dio, the perpendicular distance between the surface of the gate vestige and the optical axis is Dg, and the following condition is satisfied:
$$0.1 \leq Dg / Dio \leq 2.1 .$$

39. The imaging lens assembly of claim 33, wherein the at least one connection surface further comprises a plurality of irregular recesses, the irregular recesses are at least disposed on the surface of the gate vestige.

40. The imaging lens assembly of claim 39, wherein a disposing range of the irregular recesses further extends from the surface of the gate vestige to the divergent nozzle surface at a surrounding.

41. The imaging lens assembly of claim 33, wherein the plastic optical element further comprises a light blocking layer for blocking a light from passing therethrough, and the light blocking layer is at least disposed on the gate vestige and the divergent nozzle surface.

42. An electronic device, comprising:
the imaging lens assembly of claim 1.

43. An electronic device, comprising:
the imaging lens assembly of claim 13.

44. An electronic device, comprising:
the imaging lens assembly of claim 23.

45. An electronic device, comprising:
the imaging lens assembly of claim 33.
